(19) United States
(12) Patent Application Publication
(10) Pub. No.: US 2025/0110847 A1
(43) Pub. Date: Apr. 3, 2025

(54) ALERT GATING AND ESCALATION FOR ALERT MONITORING SERVICE TOOLS ASSOCIATED WITH SOFTWARE APPLICATION FRAMEWORKS

(71) Applicant: ATLASSIAN PTY LTD., Sydney (AU)

(72) Inventors: Halit Simsek, Çankaya/Ankara (TR); Alp Gürtan, Çankaya/Ankara (TR); Alptekin Önder, Çankaya/Ankara (TR); Halit Okumus, Çankaya/Ankara (TR); Yavuz Selim Yesilyurt, Çankaya/Ankara (TR)

(21) Appl. No.: 18/477,079

(22) Filed: Sep. 28, 2023

(51) Int. Cl. G06F 11/32; G06F 11/30

(52) U.S. Cl. CPC G06F 11/327; G06F 11/3051; G06F 11/3072

(57) ABSTRACT

Techniques for adaptive alert monitoring, routing, and escalation for one or more software application frameworks are discussed herein. Embodiments are configured to receive alert data objects related to respective alerts associated with a software application framework. Embodiments are also configured to access alert configuration parameters associated with the alert data objects and cause transmission of at least one gating alert notification associated with a gating alert data object of the alert data objects to at least one gating alert responder entity of a set of alert response entities. Embodiments are also configured to determine if the gating alert data object satisfies an escalation parameter set and generate an escalation transaction associated with the alert data objects. Embodiments are also configured to cause, based on the escalation transaction, transmission of at least one alert escalation notification to at least one alert escalation entity of the set of alert response entities.

### TECHNICAL FIELD

Embodiments of the present disclosure are generally directed to adaptive alert monitoring and alert escalation for software application frameworks.

### BACKGROUND

Various methods, apparatuses, and systems are configured to provide techniques for monitoring and routing alerts associated with a software application framework. Applicant has identified many deficiencies and problems associated with existing methods, apparatuses, and systems for monitoring and routing alerts associated with a software application framework. Through applied effort, ingenuity, and innovation, these identified deficiencies and problems have been solved by developing solutions that are in accordance with the embodiments of the present invention, many examples of which are described in detail herein.

### BRIEF SUMMARY

In one aspect, a computer-implemented method for adaptive alert monitoring, routing, and escalation for one or more software application frameworks to mitigate excessive alert escalation for said software application frameworks is provided. The computer-implemented method includes receiving, via an alert monitoring service tool, one or more alert data objects related to one or more respective alerts associated with the software application framework. The computer-implemented method also includes accessing one or more alert configuration parameters associated with the one or more alert data objects. The computer-implemented method also includes causing, based in part on the one or more alert configuration parameters, transmission of at least one gating alert notification associated with a gating alert data object of the one or more alert data objects to at least one gating alert responder entity of a set of alert response entities. The computer-implemented method also includes determining if the gating alert data object satisfies an escalation parameter set. The computer-implemented method also includes, in response to determining that the gating alert data object satisfies the escalation parameter set, generating an escalation transaction associated with the one or more alert data objects. The computer-implemented method also includes causing, based on the escalation transaction, transmission of at least one alert escalation notification to at least one alert escalation entity of the set of alert response entities.

The computer-implemented method further includes determining one or more alert response entity rules associated with the one or more alert data objects. The computer-implemented method also includes determining a visibility policy associated with the one or more alert data objects, where the visibility policy describes one or more alert response entities of the set of alert response entities that have access to view the one or more alert data objects. The computer-implemented method also includes determining a notification policy associated with the one or more alert data objects, where the notification policy describes one or more alert response entities of the set of alert response entities that have access to receive one or more of the at least one gating alert notification or the at least one alert escalation notification.

The computer-implemented method further includes where the set of alert response entities comprises at least one or more alert response teams, gating alert responders, alert escalation responders, or alert response services.

The computer-implemented method further includes where the one or more alert data objects comprise a respective escalation parameter set, and where the respective escalation parameter set comprises at least one or more alert escalation rules, alert escalation schedules, alert escalation progression time periods, alert escalation entity identifiers, or an alert escalation repetition value.

The computer-implemented method further includes where the one or more alert data objects are associated with one or more alert attributes comprising at least one or more of an alert identifier, an alert description, a tag identifier, a log identifier, a service identifier, or an alert response entity identifier.

The computer-implemented method further includes determining, via a resource allocation model associated with the alert monitoring service tool, whether the software application framework has satisfied an alert monitoring service resource threshold. The computer-implemented method also includes, in response to determining the alert monitoring service resource threshold has been satisfied, applying, based on resource allocation model output generated by the resource allocation model, a de-prioritization flag to one or more computing devices associated with the software application framework. The computer-implemented method also includes applying one or more restrictions to one or more alert monitoring service resources associated with the one or more computing devices associated with the de-prioritization flag.

The computer-implemented method further includes where the de-prioritization flag is applied to a particular end user profile associated with the one or more computing devices associated with the software application framework.

The computer-implemented method further includes where the de-prioritization flag is applied to a particular escalation transaction associated with a respective alert data object associated with the software application framework.

The computer-implemented method further includes removing the de-prioritization flag from the one or more computing devices upon determining a predefined de-prioritization period has elapsed.

The computer-implemented method further includes generating one or more alert monitoring event objects, where the one or more alert monitoring event objects are generated based on at least one of an alert routing event, an alert escalation event, or a de-prioritization event associated with a respective alert data object of the one or more alert data objects. The computer-implemented method also includes causing storage of the one or more alert monitoring event objects in at least one cloud-based storage platform associated with the alert monitoring service tool.

The computer-implemented method further includes where the one or more alert data objects are generated by an alert monitoring service application programming interface (API) associated with the alert monitoring service tool.

In a second aspect, an apparatus for adaptive alert monitoring, routing, and escalation for one or more software application frameworks to mitigate excessive alert escalation for said software application frameworks is provided. The apparatus includes a display, at least one processor, and at least one memory including program code. The at least one memory and the program code are configured to, with the at least one processor, cause the apparatus to perform any of the computer-implemented methods described herein. In a third aspect, an apparatus comprises the means for performing any of the computer-implemented methods described herein.

In a fourth aspect, a non-transitory computer-readable storage medium for adaptive alert monitoring, routing, and escalation for one or more software application frameworks to mitigate excessive alert escalation for said software application frameworks is provided. The non-transitory computer-readable storage medium includes instructions that when executed by at least one processor, cause the at least one processor to perform any of the computer-implemented methods described herein.

### BRIEF DESCRIPTION OF THE SEVERAL VIEWS OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein. To easily identify the discussion of any particular element or act, the most significant digit or digits in a reference number refer to the figure number in which that element is first introduced.

FIG. 1 is a block diagram of an exemplary software application framework monitoring architecture configured for adaptive alert monitoring and routing in accordance with one or more embodiments of the present disclosure.

FIG. 2 is a block diagram of an exemplary software application framework monitoring computing device structured in accordance with one or more embodiments of the present disclosure.

FIG. 3 is a block diagram of an exemplary client computing device structured in accordance with one or more embodiments of the present disclosure.

FIG. 4 is a block diagram of an exemplary software application framework monitoring system structured in accordance with one or more embodiments of the present disclosure.

FIGS. 5A-B illustrate an exemplary data flow diagram for generating and routing alert notifications associated with respective alert data objects in accordance with one or more embodiments of the present disclosure.

FIG. 6 illustrates a flowchart representing a method for adaptive alert monitoring, routing, and escalation for one or more software application frameworks in accordance with one or more embodiments of the present disclosure.

FIG. 7 illustrates a flowchart representing a method for employing a resource allocation model to balance alert monitoring service resource consumption for one or more software application frameworks in accordance with one or more embodiments of the present disclosure.

### DETAILED DESCRIPTION

Various embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. The terms “illustrative,” “example,” and “exemplary” are used to be examples with no indication of quality level. Like numbers refer to like elements throughout.

### Overview

Various embodiments of the present invention address technical problems associated with monitoring a software application framework for alerts and routing various alert notifications to the appropriate entities. Furthermore, embodiments of the present invention address technical problems associated with processing excessive numbers and frequency of alerts and/or alert escalations associated with a software application framework.

The disclosed techniques can be utilized by an alert monitoring service tool associated with a software application framework monitoring system to monitor one or more respective software application frameworks, route any necessary alert notifications associated with any detected alerts, as well as mitigate any redundant and/or excessive alerts and/or alert escalations generated by a respective software application framework. Alert routing (e.g., facilitating or directing the transmission of relevant alert notifications, alert escalation notifications, etc.) is an expensive and complex operation depending on various use cases and/or alert routing configurations (e.g., routing rules, escalation rules, notification schedules, etc.) associated with a respective software application framework. In some alert monitoring systems, even a single alert may cause up to 3M transactions (e.g., alert routings, escalations, amplifications, redundant notifications, and/or the like).

Some of the most problematic scenarios and bottlenecks involve alert escalation repetitions (e.g., redundant and/or looping alert escalations and/or notifications) and excessive database queries generated based on the alert escalation repetitions. In various examples, the alert escalation repetitions and/or excessive database queries may be generated as a result of a failure of an appropriate alert response entity and/or service tool to acknowledge and/or mitigate one or more alerts associated with a respective software application framework.

For example, one or more client computing devices or services associated with a respective software application framework may continuously create alerts and never acknowledge any of the alerts. Even if the one or more client computing devices or services do not create a large number of alerts, the frequency of the alerts may be consistent enough (e.g., 100 alerts per minute) to cause overhead and functionality problems. As the one or more client computing devices or services create more and more alerts, a conventional alert monitoring system may continue to process the alerts in addition to any alert escalation events spawned from previously-created and unacknowledged alerts.

As another example, in a conventional alert monitoring system, an alert event and an alert transaction (e.g., an alert notification transmission) may be triggered for each individual alert escalation associated with a respective alert. This means that if four alert escalations are being processed for the same alert there would be four different transactions for the same alert. Because many alert monitoring systems may not impose a limit on such alert escalations, there may be, in some scenarios, more than 1,000 data transactions processed for a single alert.

One example alert creation rate limit for an enterprise-level software application framework associated with a conventional alert monitoring system may be approximately 5,000 alerts per minute. Therefore, in some scenarios, if a single enterprise-level software application framework client can create 5,000 alerts per minute that could trigger more than 5M transactions per minute. Such escalations or amplifications can lead to system slowdowns, dropped services, and/or complete system crashes for an associated software application framework monitoring system.

The technical problems detailed above may be further compounded for a software application framework monitoring system that is configured to monitor and/or route alerts for multiple enterprise-level software application frameworks simultaneously. For example, resource allocations problems may be introduced when one or more software application frameworks with inefficient alert routing configurations consume excessive resources from an alert monitoring system that is intended to service multiple software application frameworks simultaneously. Said differently, one or more software application frameworks may experience an increase in unmitigated alerts, lapses in a respective alert monitoring service, alert monitoring service connectivity issues, alert notification communication issues, alert data storage issues, undue computation expense associated with alert processing, high or uneven system load, and/or the like due to the excessive resource consumption, redundant alert generation and escalation, excessive alert database queries, high traffic, and/or bandwidth issues.

It is therefore desirable to increase the efficiency, processing, and scalability of a software application framework monitoring system. Embodiments of the present disclosure provide various technical improvements compared to other alert monitoring systems by employing improved methods and architectures configured to adaptively monitor, route, and/or escalate alerts associated with one or more software application frameworks. Furthermore, embodiments of the present disclosure are configured to mitigate the excessive generation of alerts, alert escalations, and escalation transactions in order to balance the resource consumption of the one or more software application frameworks.

Embodiments described herein provide the technical benefit of automatically, efficiently, and simultaneously monitoring, routing, and/or escalating alerts for multiple client computing devices associated with one or more respective software application frameworks, thereby reducing the computational load associated with the respective software application frameworks as well as for said client computing devices. Additionally, the embodiments described herein reduce the time, human resources, and mental load on one or more end users (e.g., alert response entities) associated with one or more respective software application frameworks.

To address the aforementioned technical problems, embodiments described herein employ a software application framework monitoring system comprising an alert monitoring service tool configured to adaptively monitor, route, and/or escalate alerts associated with one or more software application frameworks. For example, embodiments may be configured to generate, receive, and/or retrieve one or more alert data objects related to one or more respective alerts, cautions, problems, errors, issues, and/or incidents associated with the one or more software application frameworks.

Furthermore, the alert monitoring service tool may be configured to facilitate the generation, routing, and/or transmission of one or more alert notifications (e.g., gating alert notifications, alert escalation notifications, and/or the like) associated with one or more respective alerts related to the one or more software application frameworks. In this regard, the alert monitoring service tool may be configured to resolve the routing and/or transmission of the one or more alert notifications to one or more appropriate alert response entities associated with a respective software application framework.

In various examples, the alert monitoring service tool may be configured to evaluate one or more alert data objects as part of an “alert gating” operation. For example, as part of the alert gating operation, the alert monitoring service tool may determine, based on one or more portions of data (e.g., alert severity data) associated with a respective alert data object, that an alert notification associated with the respective alert data object is to be transmitted to one or more alert response entities 118. Alternatively, the alert monitoring service tool may determine, based on one or more portions of data (e.g., alert severity data) associated with a respective alert data object, to revert (e.g., remit, defer, bypass, etc.) the alert back to the respective software application framework without routing an alert notification to one or more alert response entities. As such, the alert monitoring service tool may cause, based in part on one or more alert configuration parameters associated with a particular alert, the transmission of a gating alert notification (e.g., a first alert notification) to at least one predetermined gating alert responder entity (e.g., a low-tier alert response entity) of a set of alert response entities associated with the respective software application framework.

The alert monitoring service tool may also be configured to determine whether a respective alert is to be “escalated” (e.g., flagged as a high priority and/or routed to one or more specific alert escalation entities). In various embodiments, the alert monitoring service tool may determine, based at least in part on an escalation parameter set, whether a particular alert is to be escalated and how the particular alert is to be escalated based on one or more alert escalation configuration parameters comprised in an escalation parameter set (e.g., an alert escalation schedule, alert escalation rules, and/or the like) associated with the particular alert. In various examples, an escalation parameter set associated with a respective alert may comprise data indicating an alert severity level, an alert priority level, an alert importance, an alert ranking, and/or the like.

In this regard, embodiments of the present disclosure improve the technical shortcomings of conventional alert monitoring systems by working in a multi-escalation fashion. For example, the alert monitoring service tool may be configured to generate a single escalation transaction for each alert in order to reduce and/or eliminate excessive, redundant alert escalations and/or alert escalation notification transmissions. Employing a single escalation transaction to facilitate the generation and/or transmission of the alert escalations related to a single alert allows for efficient, transaction-scoped alert data caching, optimization of complex alert monitoring use cases, and balance of alert monitoring resource consumption across one or more software application frameworks.

Additionally, the alert monitoring service tool is configured to mitigate excessive alert escalation in a software application framework such that the one or more services, applications, features, tools, and/or products associated with the one or more software application frameworks are not adversely impacted (e.g., are not impacted by bandwidth and/or resource limitations caused by high alert traffic and/or excessive alert escalation). In this regard, the alert monitoring service tool may be configured to employ a machine-learning based resource allocation model to adaptively balance the alert monitoring service resource consumption for the one or more software application frameworks associated with a respective software application framework monitoring system.

As such, embodiments of the present disclosure are configured to eliminate redundant and/or excessive alert data generation, alert data input, and/or alert data output related to one or more alert computations, alert escalations, and/or alert notification transmissions. Furthermore, embodiments of the present disclosure are configured to prevent race conditions and inefficient system performance caused by the poor implementation and insufficient architectures of conventional alert monitoring systems.

### Definitions

The term “software application framework,” refers to a software platform comprising one or more types of software applications (e.g., a monolithic platform and/or a service-oriented platform), which are described in more detail below. A software application framework may be a distributed framework wherein the one or more types of software applications (e.g., monolithic platforms and/or service-oriented platforms) may be configured to interface, integrate, transfer data, and/or otherwise communicate with one another via a respective communications network.

The terms “monolithic platform,” or “monolithic software platform,” refer to a software application designed to embody a single-tiered architecture in which the front end and back end systems are combined into a single platform. Monolithic software platforms are self-contained in that they can perform each operation needed to complete their intended purpose or function. Such example monolithic platforms may include Micros™ by Atlassian® platform or DynamoDB® by Amazon®.

The term “service-oriented platform” refers to a software application designed to embody a modular programming architecture based on specific service types, wherein the modular programming may comprise existing services combined by user specification in order to create a custom software application. In some embodiments, the services within the modular programming may configure GUI for user interaction with each service in an individual manner without affecting other services within the service-oriented platform. A service-oriented platform is typically characterized by large networks of interdependent services and microservices that support a myriad of software features and applications. Indeed, some large service-oriented platforms may be comprised of topologies of 1,500 or more interdependent services and microservices. Such service-oriented platforms are nimble, highly configurable, and enable robust collaboration and communication between users at individual levels, team levels, and enterprise levels. Service-oriented platforms typically include large numbers of software applications. Each software application includes a number of features, with many features (e.g., user authentication features) shared between multiple software applications. Other features are supported only by one associated software application or a defined subset of software applications.

A given service-oriented platform could support hundreds of software applications and hundreds of thousands of features. Those applications and features could be supported by thousands of services and microservices that exist in vast and ever-changing interdependent layers. Adding to this complexity is the fact that at any given time, a great number of software development teams may be constantly, yet unexpectedly, releasing code updates that change various software services, launch new software services, change existing features of existing software applications, add new software applications, add new features to existing software applications, and/or the like.

The term “alert monitoring service tool” refers to a software service that is configured to monitor a software application framework (e.g., associated with a monolithic software platform and/or a service-oriented platform) and may be deployed via a combination of computer hardware and/or software associated with a respective software application framework monitoring system. The alert monitoring service tool is configured to detect alerts, cautions, problems, errors, issues, and/or incidents associated with the software application framework. Alert monitoring service tools are configured to mitigate excessive alert escalation in a software application framework such that the one or more services, applications, features, tools, and/or products associated with the software application framework are not adversely impacted (e.g., are not impacted by bandwidth and/or resource limitations caused by high alert traffic and/or excessive alert escalation). An example alert monitoring service tool is Opsgenie® by Atlassian®.

Alert monitoring service tools may be configured to generate and/or receive one or more alert data objects related to the one or more respective alerts, cautions, problems, errors, issues, and/or incidents associated with the software application framework. Alert monitoring service tools may also be configured to generate one or more alert notifications (e.g., gating alert notifications, alert escalation notifications, and/or the like) related to the one or more respective alerts, cautions, problems, errors, issues, and/or incidents. Furthermore, alert monitoring service tools may also facilitate the routing and/or transmission of said alert notifications to one or more appropriate alert response entities (e.g., alert response teams, alert escalation entities, and/or the like) associated with the software application framework. An alert monitoring service tool may comprise, integrate with, and/or otherwise employ a resource allocation model to mitigate any adverse impacts to the software application framework and/or the software application framework monitoring system caused by excessive alert generation, excessive alert escalation, and/or excessive resource consumption by one or more components of the software application framework.

The term “alert data object” refers to an electronically managed data object that is configured to comprise various data, information, text, and/or other media used to describe a respective alert, caution, problem, error, issue, and/or incident associated with a software application framework. As such, alert data objects are configured to describe the operating functionality of a software application framework (e.g., monolithic platform and/or the service-oriented platform). Such operating functionality may include indicators regarding the performance of the software application framework (e.g., whether the various components of the software application framework functions are running at peak speed or slower than peak speed, if certain functions or capabilities are not running at peak performance or are not running at all, etc.). Alert data objects may comprise one or more alert attributes, one or more alert configuration parameters, and/or an escalation parameter set. Alert data objects and/or one or more portions of data related to alert data objects may be generated and/or received by an alert monitoring service tool and stored in a data storage subsystem of a software application framework monitoring system. In various contexts, alert data objects may be used by the alert monitoring service tool to generate and/or cause the transmission of one or more alert notifications.

The term “alert attribute” refers to data, text, identifiers, metadata, or other alert related characteristics or features that are extracted from and/or otherwise associated with a respective alert, caution, problem, error, issue, and/or incident related to a software application framework. Example alert attributes include an alert identifier, an alert description, a tag identifier, a log identifier, a service identifier, and/or at least one alert response entity identifier.

The term “alert identifier” refers to one or more items of data by which an alert may be identified within a software application framework monitoring system. For example, an alert identifier may comprise text string(s), numerical character(s), alphabetical character(s), alphanumeric code(s), ASCII character(s), a pointer, an IP address, a MAC address, a memory address, other unique identifier, or a combination thereof.

The term “log identifier” refers to one or more items of data by which a historical log of current alerts, past alerts, and/or alert response teams may be captured by the alert monitoring service tool within a software application framework monitoring system. For example, a log identifier may comprise data by which a log of actions taken on an alert are stored, which may include data of an alert being acknowledged by one or more entities associated with a respective alert response team, data of an alert being resolved by one or more response teams, and/or data of one or more response teams being added to (e.g., associated with) an alert data object related to a respective alert. A log identifier may comprise text string(s), numerical character(s), alphabetical character(s), alphanumeric code(s), ASCII character(s), a pointer, an IP address, a MAC address, a memory address, other unique identifier, or a combination thereof.

The term “tag identifier” refers to one or more items of data by which an alert data object is tagged by the software application framework within a software application framework monitoring system. For example, a tag identifier may comprise text string(s), numerical character(s), alphabetical character(s), alphanumeric code(s), ASCII character(s), a pointer, an IP address, a MAC address, a memory address, other unique identifier, or a combination thereof.

The term “service identifier” refers to one or more items of data by which a service (e.g., feature, application, product, etc.) associated with a software application framework may be identified. In some embodiments, the service identifier may comprise data indicating the upstream and downstream services for each specific service associated with the software application framework. In some embodiments, the service identifier may comprise service tier level data to indicate the importance of the service (e.g., the importance of the service to an enterprise and/or end user using the software application framework) for the user of the software application framework (e.g., monolithic platform and/or the service-oriented platform). In some embodiments, the service identifier may comprise data associated with other service identifiers which may indicate the number of impacted services from an alert of a specific service. In some embodiments, a particular service identifier (e.g., and therefore a particular service) may be associated with specific alert response team within a software application framework monitoring system. A service identifier may comprise text string(s), numerical character(s), alphabetical character(s), alphanumeric code(s), ASCII character(s), a pointer, an IP address, a MAC address, a memory address, other unique identifier, or a combination thereof.

The term “alert response entity identifier” refers to one or more items of data by which a respective alert response entity (e.g., an alert response team, an alert response service, and/or the like) may be identified within a software application framework monitoring system. The alert response entity identifier may be used as a means to classify specific alert response entities (e.g., alert responders and/or alert escalation responders) for determining a visibility policy and/or a notification policy associated with one or more alert data objects. An alert response entity identifier may comprise text string(s), numerical character(s), alphabetical character(s), alphanumeric code(s), ASCII character(s), a pointer, an IP address, a MAC address, a memory address, other unique identifier, or a combination thereof.

The term “alert response entities” refers to one or more entities associated with one or more respective personnel and/or responsible parties related to a software application framework that are intended to receive, review, acknowledge, mitigate, and/or otherwise manage alerts associated with the software application framework. In various embodiments, a set of alert response entities associated with a software application framework may comprise one or more alert response teams, gating alert responders, alert escalation responders, alert response services (e.g. third-party alert response services), and/or any other entity capable of receiving, reviewing, acknowledging, mitigating, and/or otherwise managing alerts.

The term “alert configuration parameters” refers to a set of predetermined parameters associated with a respective alert data object that are configured to indicate the manner in which a respective alert is to be resolved, handled, routed, and/or otherwise managed by an alert monitoring service tool. A set of alert configuration parameters associated with an alert data object may comprise, but is not limited to, one or more alert response entity rules, data related to one or more alert response entities, data related to a respective alert response team, data related to a visibility policy associated with the alert data object, data related to a notification policy associated with the alert data object, and/or data related to an escalation parameter set. An alert monitoring service tool may employ one or more portions of data associated with one or more configuration parameters to generate and/or route (e.g., facilitate the transmission of) one or more alert notifications (e.g., gating alert notifications, alert escalation notifications, and/or the like) to one or more alert response entities associated with a respective software application framework.

The term “alert response entity rules” refers to a set of predefined rules related to the distribution, scheduling, and/or transmission requirements for one or more alert notifications associated with a respective alert data object. An alert monitoring service tool may use a set of alert response entity rules to determine a hierarchy of one or more alert response entities associated with a respective software application framework (e.g., a hierarchy of one or more members of a respective alert response team). In some embodiments, the alert response entity rules may also dictate a preferred form of communication associated with one or more alert response entities and, therefore, a respective type of alert notification (e.g., email, SMS message, etc.) to be transmitted to the one or more alert response entities.

The term “visibility policy” refers to a description of a set of alert response entities associated with a respective software application framework that have access (e.g., permission) to view data associated with a respective alert data object. In various examples, a visibility policy may indicate one or more specific alert response entity identifiers associated with one or more respective alert response entities that have been granted access to view the data associated with a respective alert data object.

The term “notification policy” refers to a description of a set of alert response entities associated with a respective software application framework that have access (e.g., permission) and/or are intended to receive one or more alert notifications (e.g., gating alert notifications and/or alert escalation notifications) associated with a respective alert data object. In various examples, a notification policy may indicate one or more specific alert response entity identifiers associated with one or more respective alert response entities that have been granted access and/or have been indicated to receive one or more alert notifications associated with a respective alert data object.

The term “escalation parameter set” refers to at least one or more alert escalation configuration parameters including, but not limited to, one or more alert escalation rules, alert escalation schedules, alert escalation progression time periods, alert escalation entity identifiers, and/or an alert escalation repetition value associated with a respective alert data object. In various embodiments, a respective escalation parameter set associated with an alert data object may comprise data indicating an alert severity level, an alert priority level, an alert importance, an alert ranking, and/or the like associated with a respective alert. For example, an associated alert severity level may indicate whether the alert needs to be escalated (e.g., brought to the attention of multiple and/or specific alert response entities) if the alert is not mitigated and/or acknowledged by a first alert response entity (e.g., a gating alert responder entity) within a predetermined alert escalation progression time period.

The term “escalation transaction” refers to an electronically managed data object comprising one or more portions of executable computer code configured to facilitate the communication (e.g., transmission) of one or more alert notifications (e.g., alert escalation notifications) to one or more alert response entities associated with a respective alert response team. An escalation transaction may be generated by an alert monitoring service tool based on at least one of one or more alert configuration parameters and/or an escalation parameter set associated with an alert data object.

In various examples, an alert monitoring service tool can generate a single escalation transaction associated with a respective alert data object and, as such, the single escalation transaction can be employed to facilitate the transmission of one or more alert escalation notifications to one or more respective alert response entities. The use of a single escalation transaction to facilitate the communications of the one or more alert escalation notifications reduces the number of redundant alert data objects and/or alert escalation objects generated for an unacknowledged alert by conventional alert monitoring service tools. For example, a single escalation transaction may be used to communicate multiple alert escalation notifications for an alert escalation that is repeated (e.g., looped, cycled, etc.) according to an escalation repetition value associated with a respective alert data object.

The term “resource allocation model” refers to a machine learning (ML) model associated with an alert monitoring service tool configured to mitigate any adverse impacts to a respective software application framework and/or a respective software application framework monitoring system caused by excessive alert generation, excessive alert escalation, and/or excessive resource consumption by one or more components of the software application framework. In this regard, a resource allocation model is configured to adaptively balance the alert monitoring service resource consumption for one or more software application frameworks.

A resource allocation model may be configured to determine whether a software application framework has satisfied (e.g., met and/or exceeded) an alert monitoring service resource threshold. The alert monitoring service resource threshold may be associated with a predetermined allotment of software application framework monitoring resources, communications network resources, personnel resources, computational resources, data storage resources, and/or the like that have been provided for a respective software application framework.

A resource allocation model may be configured to, in response to determining that an alert monitoring service resource threshold has been satisfied (e.g., met and/or exceeded) for a respective software application framework, apply a de-prioritization flag to one or more computing devices associated with the software application framework. As such, the resource allocation model may be configured to apply one or more restrictions to one or more alert monitoring service resources associated with the one or more computing devices associated with the de-prioritization flag. In various embodiments, a resource allocation model (and/or one or more models associated with the resource allocation model) may be trained in part using one or more portions of alert data associated with one or more alert data objects that have been generated, received, stored, and/or otherwise managed by an alert monitoring service tool associated with a respective software application framework monitoring system.

In various examples, the resource allocation model may comprise, employ, direct, and/or otherwise integrate with one or more ML models, artificial intelligence (AI) models, rules-based models, artificial neural networks (ANNs), convolutional neural networks (CNNs), recurrent neural networks (RNNs), and/or any other type of specially trained models that are configured to monitor the resource consumption of one or more respective software application frameworks. The one or more ML models, AI model, rules-based models, ANNs, CNNs, RNNs, and/or other types of models may also be configured to mitigate any excessive resource consumption associated with one or more components of the one or more respective software application frameworks.

The term “alert monitoring event object” refers to a data object generated by an alert monitoring service tool upon the execution and/or completion of various events related to the monitoring of a respective software application framework. An alert monitoring service tool may be configured to generate one or more alert monitoring event objects associated with one or more respective alert routing events, alert escalation events, and/or de-prioritization events associated with a respective alert data object. Alert monitoring event objects may be used for alert reporting, alert analysis, and/or alert logging purposes.

In various examples, one or more alert monitoring event objects may be stored, accessed, received, transmitted to, and/or otherwise managed by a data storage subsystem associated with a software application framework monitoring system. Additionally or alternatively, in various examples, one or more alert monitoring event objects may be stored, accessed, received, transmitted to, and/or otherwise managed by one or more cloud-based storage platforms (e.g., cloud-based databases, cloud-based data-querying tools, and/or the like) associated with the software application framework monitoring system. Examples of cloud-based storage systems include Redis® by Redis Ltd.®, DynamoDB® by Amazon Web Services®, and Elasticsearch® by Elasticsearch BV.

The terms “computer-readable storage medium” refers to a non-transitory, physical, or tangible storage medium (e.g., volatile or non-volatile memory), which may be differentiated from a “computer-readable transmission medium,” which refers to an electromagnetic signal.

The term “client computing device” refers to a combination of computer hardware and/or software that is configured to access a service made available by a software application framework. Client computing devices may include, without limitation, smart phones, tablet computers, laptop computers, wearables, personal computers, enterprise computers, and the like.

The term “software application framework monitoring computing device” refers to a combination of computer hardware and/or software that is configured to provide a service to a client device. In various examples, a software application framework monitoring computing device may embody, be embodied by, interface with, integrate with, and/or otherwise be associated with a software application framework monitoring system. In some examples, a software application framework monitoring computing device is configured to communicate with one or more client computing devices using one or more computer networks.

The term “unit” refers to a combination of computer hardware and/or software associated with a respective computing device (e.g., a software application framework monitoring computing device) that is configured to execute one or more portions of executable computer program code configured to implement, facilitate, and/or manage the one or more techniques, methods, and/or processes described herein.

As used herein, the terms “data,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

### Example Systems and Apparatuses of the Disclosure

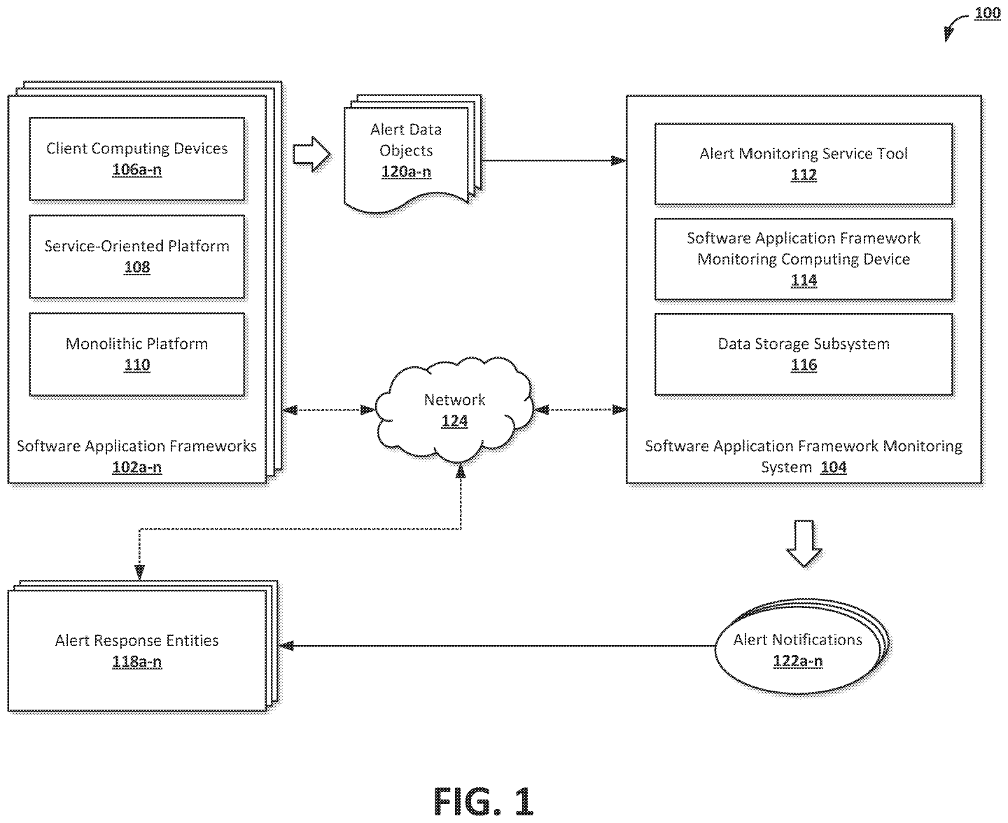

FIG. 1 is a block diagram of an exemplary software application framework monitoring architecture 100 configured for adaptive alert monitoring and routing in accordance with one or more embodiments of the present disclosure. The software application framework monitoring architecture 100 comprises software application frameworks 102a-n, a software application framework monitoring system 104, alert response entities 118a-n, and network 124. As depicted, a respective software application framework 102a may comprise client computing devices 106a-n, a service-oriented platform 108, and/or a monolithic platform 110. The software application framework monitoring system 104 may comprise an alert monitoring service tool 112, a software application framework monitoring computing device 114, and/or a data storage subsystem 116.

Each of the components comprised in the software application framework monitoring architecture 100 are configured to work in tandem to facilitate the adaptive monitoring, routing, and/or escalation of one or more alerts, cautions, problems, errors, issues, and/or incidents associated with one or more software application frameworks 102a-n. For example, in various embodiments, the software application framework monitoring computing device 114 may be configured to embody, integrate with, interface with, and/or otherwise direct the alert monitoring service tool 112 in order to execute the one or more techniques, methods, processes, and/or operations described herein. Additionally, the software application framework monitoring computing device 114 may be configured to embody, integrate with, interface with, and/or otherwise direct the data storage subsystem 116 to store, receive, retrieve, transmit, and/or otherwise manage one or more portions of data related to one or more alert data objects 120a-n.

The various components of the software application frameworks 102a-n (e.g., the client computing devices 106a-n), the software application framework monitoring system 104 (e.g., the software application framework monitoring computing device 114), and/or the alert response entities 118a-n may communicate over the network 124. The network 124 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.).

For example, the network 124 may include a cellular telephone, a wireless network 802.11, 802.16, 802.20, and/or WiMAX network. Further, the network 124 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of the page management system. In some embodiments, the protocol is a custom protocol of JavaScript Object Notation (JSON) objects sent via a WebSocket channel. In some embodiments, the protocol is JSON over RPC, JSON over REST/HTTP, and the like.

As shown in FIG. 1, a software application framework monitoring system 104 may be configured to receive and/or retrieve one or more alert data objects 120a-n from one or more software application frameworks 102a-n. For example, the alert monitoring service tool 112 may be configured to monitor the one or more software application frameworks 102a-n to receive and/or retrieve the one or more alert data objects 120a-n. The alert data objects 120a-n may be configured to comprise, indicate, point to, and/or or otherwise describe one or more portions of data related to a respective alert, caution, problem, error, issue, and/or incident associated with a respective software application framework of the software application frameworks 102a-n.

For example, one or more alert data objects 120a-n may be associated with an alert related to the performance, functionality, and/or status of one or more hardware components, software components, network systems, security systems, applications, services, products, user profiles, authentications, and/or the like associated with a service-oriented platform 108 and/or a monolithic platform 110 associated with a respective software application framework of the software application frameworks 102a-n. In this regard, the alert data objects 120a-n may comprise one or more alert attributes, one or more alert configuration parameters, and/or an escalation parameter set associated with a respective alert.

In various examples, the one or more alert data objects 120a-n may be generated by an alert monitoring service application programming interface (API) associated with the alert monitoring service tool 112. For example, the one or more software application frameworks 102a-n associated with the software application framework monitoring system 104 may embody, integrate with, interface with, and/or otherwise employ an alert monitoring service API associated with the alert monitoring service tool 112. In such examples, the alert monitoring service API may be configured to automatically generate an alert data object 120a upon the detection of a respective alert, caution, problem, error, issue, and/or incident associated with a respective software application framework of the software application frameworks 102a-n. As such, the alert monitoring service tool 112 may, in various examples, automatically receive one or more alert data objects 120a-n generated by the alert monitoring service API.

The alert monitoring service tool 112 may be configured to determine whether to generate, route, and/or cause transmission of one or more alert notifications 122a-n based on the one or more alert data objects 120a-n. In various examples, the one or more alert notifications 122a-n may be configured as at least one of an email notification, a push notification, an SMS notification, a text message notification, an automated phone notification, and/or any other means of data transmission configured convey data related to a respective alert data object 120a to one or more alert response entities 118a-n. In various examples, the alert monitoring service tool 112 may be configured to cause transmission of one or more alert notifications 122a-n to the one or more alert response entities 118a-n via the network 124.

The one or more alert response entities 118a-n may be one or more entities associated with one or more respective personnel and/or responsible parties related to a software application framework that are intended to receive, review, acknowledge, mitigate, and/or otherwise manage alerts associated with a respective software application framework 102a. In various embodiments, a set of alert response entities 118a-n associated with a software application framework 102a may comprise one or more alert response teams, gating alert responders, alert escalation responders, alert response services (e.g. third-party alert response services), and/or any other entity capable of receiving, reviewing, acknowledging, mitigating, and/or otherwise managing alerts.

In various embodiments, a respective alert response team related to a respective software application framework 102a may be associated with one or more alert responder profiles, gating alert responder profiles, alert escalation responder profiles, developer profiles, management profiles, administrative profiles, IT assistance profiles, help desk profiles, and/or the like. In such embodiments, the one or more profiles associated with the alert response team may be associated with a respective hierarchy, a specific level of access permissions, and/or a respective priority level. In various examples, the one or more profiles associated with the alert response team may be associated with one or more respective client computing devices 106a-n. In one or more embodiments, one or more alert response entities 118a-n (e.g., alert responder entities and/or escalation entities) may be embodied by, integrated with, and/or otherwise associated with one or more respective third-party alert response services (e.g., cloud-based alert mitigation services, cloud-based alert data storage platforms, and/or the like) associated with the software application framework 102a.

The alert monitoring service tool 112 may be configured to determine one or more alert response entities 118a-n that have access permissions to view and/or receive data associated with one or more respective alert data objects 120a-n and/or one or more alert notifications 122a-n. For example, the alert monitoring service tool 112 may be configured to determine a visibility policy and/or a notification policy associated with the one or more alert data objects 120a-n.

In one or more examples, a visibility policy may be a description of a set of alert response entities 118a-n associated with a respective software application framework 102a that have access (e.g., permission) to view data associated with a respective alert data object 120a. For example, a visibility policy may describe at least one or more gating alert responder entities and/or one or more alert escalation entities associated with a respective set of alert response entities 118a-n that have access to view the data associated with a respective alert data object 120a. In various examples, the alert monitoring service tool 112 may be configured to determine the visibility policy based in part on one or more alert attributes and/or one or more alert configuration parameters associated with the respective alert data object 120a.

In one or more examples, a notification policy may be a description of a set of alert response entities 118a-n associated with a respective software application framework 102a that have access (e.g., permission) and/or are intended to receive one or more alert notifications 122a-n (e.g., gating alert notifications and/or alert escalation notifications) associated with a respective alert data object 120a. For example, a notification policy may describe at least one or more gating alert responder entities and/or one or more alert escalation entities associated with a respective set of alert response entities 118a-n that have access (e.g., permission) and/or are intended to receive one or more alert notifications 122a-n associated with a respective alert data object 120a-n. In various examples, the alert monitoring service tool 112 may be configured to determine the notification policy based in part on one or more alert attributes and/or one or more alert configuration parameters associated with the respective alert data object 120a.

In various examples, the alert monitoring service tool 112 may be configured to evaluate the one or more alert data objects 120a-n as part of an alert gating operation. For example, as part of the alert gating operation, the alert monitoring service tool 112 may determine, based on one or more portions of data (e.g., alert severity data) associated with a respective alert data object 120a, that an alert notification 122a associated with the respective alert data object 120a is to be transmitted to one or more alert response entities 118a-n.

Alternatively, the alert monitoring service tool 112 may determine, based on one or more portions of data (e.g., alert severity data) associated with a respective alert data object 120a, to revert (e.g., remit, defer, bypass) the alert back to the respective software application framework 102a without routing an alert notification 122a to one or more alert response entities 118a-n. Additionally or alternatively, in one example, the alert monitoring service tool 112 may determine that an alert associated with the respective alert data object 120a is an informative alert (e.g., a non-urgent and/or system status alert) and that no corresponding alert notification is to be generated and/or transmitted. As another example, the alert monitoring service tool 112 may determine that an alert associated with the respective alert data object 120a is a scheduled alert (e.g., based on one or more alert configuration parameters) and may defer generating and/or transmitting a corresponding alert notification until the scheduled time.

As a result of the aforementioned alert gating operation, the alert monitoring service tool 112 may determine that a first alert notification 122a (e.g., a gating alert notification) is to be generated based on a respective alert data object 120a and transmitted to one or more respective alert response entities 118a-n (e.g., as defined by the respective notification policy). The first alert notification 122a (e.g., the gating alert notification) may be routed to a first set of respective alert response entities 118a-n, where the first set of respective alert response entities 118a-n comprise one or more gating alert responders. In various examples, the one or more gating alert responders may be one or more low-tier alert response entities configured as a first line of alert mitigation for the respective software application framework 102a. The one or more gating alert responders may be determined based in part on one or more alert response entity rules associated with the respective alert data object 120a.

In various embodiments, once an initial gating alert notification associated with a respective alert has been transmitted to one or more alert response entities 118a-n (e.g., one or more gating alert responders), the alert monitoring service tool 112 may determine whether the respective alert is to be escalated. In various examples, the alert monitoring service tool 112 may determine whether the respective alert is to be escalated based on an escalation parameter set associated with the respective alert data object 120a.

In this regard, the alert monitoring service tool 112 may be configured to generate an escalation transaction associated with an alert data object 120a related to a respective alert. The alert monitoring service tool 112 may employ an escalation transaction to facilitate the communication (e.g., transmission) of one or more alert notifications 122a-n (e.g., alert escalation notifications) to one or more alert response entities 118a-n (e.g., a respective alert response team, one or more alert escalation responders, and/or the like). The escalation transaction may be generated by the alert monitoring service tool 112 based on at least one of one or more alert configuration parameters and/or an escalation parameter set associated with the alert data object 120a.

In one or more embodiments, the alert monitoring service tool 112 may be configured to employ a resource allocation model to mitigate any adverse impacts to the one or more software application frameworks 102a-n and/or the software application framework monitoring system 104. In various examples, the adverse impacts may be caused by one or more of excessive alert generation, excessive alert escalation, and/or excessive resource consumption by one or more components of one or more respective software application frameworks 102a-n. In this regard, the alert monitoring service tool 112 may employ the resource allocation model to adaptively balance the alert monitoring service resource consumption for the one or more software application frameworks 102a-n.

In various examples, the alert monitoring service tool 112 may employ the resource allocation model to determine whether a particular software application framework 102a of the one or more software application frameworks 102a-n has satisfied (e.g., met and/or exceeded) an alert monitoring service resource threshold. The alert monitoring service resource threshold may be associated with a predetermined allotment of software application framework monitoring resources, communications network resources, personnel resources, computational resources, data storage resources, and/or the like that have been provided for the particular software application framework 102a.

In various examples, the resource allocation model may generate one or more portions of resource allocation model output in response to determining that an alert monitoring service resource threshold has been satisfied (e.g., met and/or exceeded) for a respective software application framework 102a. Based on the one or more portions of resource allocation model output, the alert monitoring service tool 112 may apply a de-prioritization flag to one or more client computing devices 106a-n associated with the respective software application framework 102a. As such, the alert monitoring service tool 112 may be configured to apply one or more restrictions to one or more alert monitoring service resources associated with the one or more client computing devices 106a-n associated with the de-prioritization flag.

In some examples, based on resource allocation model output, a de-prioritization flag may be applied to a particular end user profile associated with the one or more client computing devices 106a-n associated with the respective software application framework 102a. Additionally or alternatively, a de-prioritization flag may be applied to a particular escalation transaction associated with a respective alert data object 120a associated with the respective software application framework 102a based on resource allocation model output. Furthermore, the alert monitoring service tool 112 may be configured to remove a de-prioritization flag from one or more client computing devices 106a-n upon determining that a predefined de-prioritization period has elapsed (e.g., a period of fifteen minutes).

In various embodiments, an alert monitoring service tool 112 may be configured to generate one or more alert monitoring event objects associated with one or more respective alert routing events, alert escalation events, and/or de-prioritization events associated with a respective alert data object. A respective software application framework monitoring system 104 may employ alert monitoring event objects for alert reporting, alert analysis, and/or alert logging purposes.

In various examples, one or more alert monitoring event objects may be published to, transmitted to, stored in, accessed by, received by, retrieved by, and/or otherwise managed by a data storage subsystem 116 associated with a software application framework monitoring system 104. Additionally or alternatively, in various examples, one or more alert monitoring event objects may be published to, transmitted to, stored in, accessed by, received by, retrieved by, and/or otherwise managed by one or more cloud-based storage platforms (e.g., cloud-based databases, cloud-based data-querying tools, and/or the like) associated with the software application framework monitoring system 104. In one or more embodiments, the alert monitoring service tool 112 may be configured to publish, transmit, and/or cause storage of the one or more alert monitoring event objects asynchronously (e.g., at a later time than when the alert monitoring event objects are created). In various examples, the asynchronous publishing, transmission, and/or storage of the one or more alert monitoring event objects may be based on at least one of a publishing schedule and/or a publishing rule set associated with a respective software application framework 102a.

In one example, an alert monitoring service tool 112 may generate an alert monitoring event object that describes the routing of an alert notification 122a. An alert monitoring event object associated with an alert routing event may comprise one or more portions of data configured to describe an alert notification 122a that was routed (e.g., transmitted) to one or more respective alert response entities 118a-n. For example, an alert monitoring event object associated with an alert routing event may comprise at least one or more portions of data related to one or more alert attributes, software application framework components, alert response entities 118a-n, client computing devices 106a-n, and/or the software application framework monitoring computing device 114 associated with the alert routing event.

As another example, an alert monitoring service tool 112 may generate an alert monitoring event object that describes the escalation of a respective alert. An alert monitoring event object associated with an alert escalation event may comprise one or more portions of data configured to describe an alert notification 122a configured as an alert escalation notification that was routed (e.g., transmitted) to one or more respective alert response entities 118a-n. For example, an alert monitoring event object associated with an alert escalation event may comprise at least one or more portions of data related to one or more alert attributes, alert escalation configuration parameters, software application framework components, alert response entities 118a-n, client computing devices 106a-n, and/or the software application framework monitoring computing device 114 associated with the alert escalation event.

As yet another example, an alert monitoring service tool 112 may generate an alert monitoring event object that describes a de-prioritization of one or more components of a software application framework 102a implemented based on resource allocation model output generated by a resource allocation model. An alert monitoring event object associated with a de-prioritization event may comprise one or more portions of data configured to describe the restriction of one or more alert monitoring service resources implemented by the alert monitoring service tool 112. For example, an alert monitoring event object associated with a de-prioritization event may comprise at least one or more portions of data related to one or more software application framework components associated with the alert monitoring resource restrictions, excessive and/or redundant alerts generated by the software application framework 102a, alert response entities 118a-n responsible for mitigating the escalated alert, client computing devices 106a-n, and/or the software application framework monitoring computing device 114 associated with the de-prioritization event.

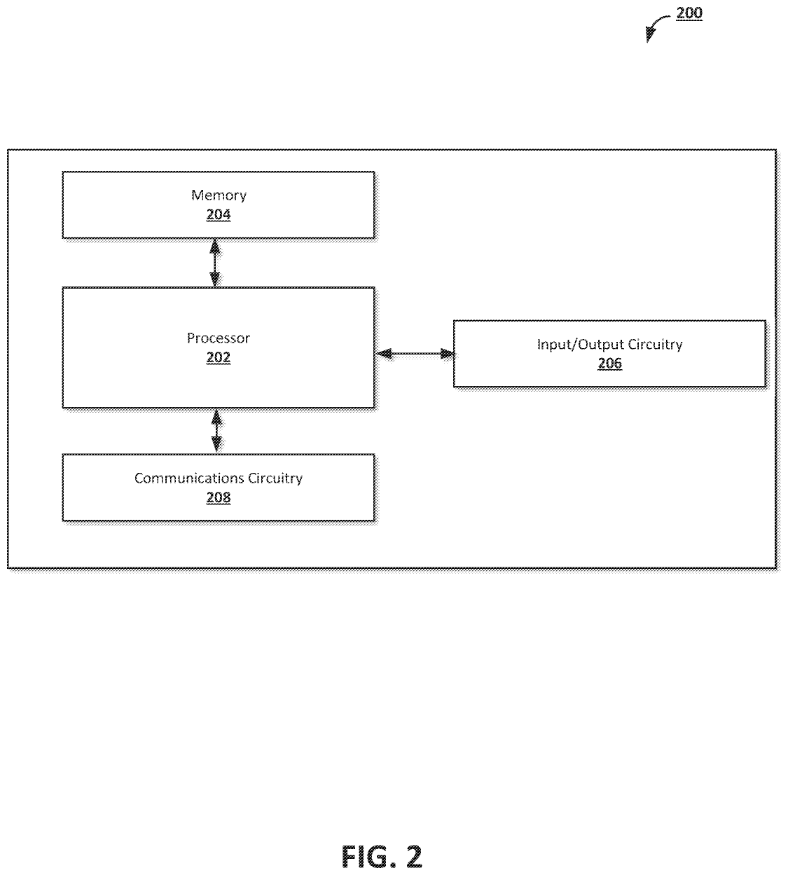

FIG. 2 illustrates a block diagram 200 of an exemplary software application framework monitoring computing device 114 structured in accordance with one or more embodiments of the present disclosure. The software application framework monitoring computing device 114 may be embodied by one or more computing systems. The software application framework monitoring computing device 114 may include processor 202, memory 204, input/output circuitry 206, and communications circuitry 208. The software application framework monitoring computing device 114 may be configured to execute the operations described herein. Although these components 202-208 are described with respect to functional limitations, it should be understood that the particular implementations necessarily include the use of particular hardware. It should also be understood that certain of these components 202-208 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In various embodiments, the processor 202 may be configured to execute instructions stored in the memory 204 or otherwise accessible to the processor 202. In some non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the software application framework monitoring computing device 114 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the software application framework monitoring computing device 114. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of software application framework monitoring computing device 114. In some embodiments, one or more external systems (such as a remote cloud computing and/or data storage system) may also be leveraged to provide at least some of the functionality discussed herein.

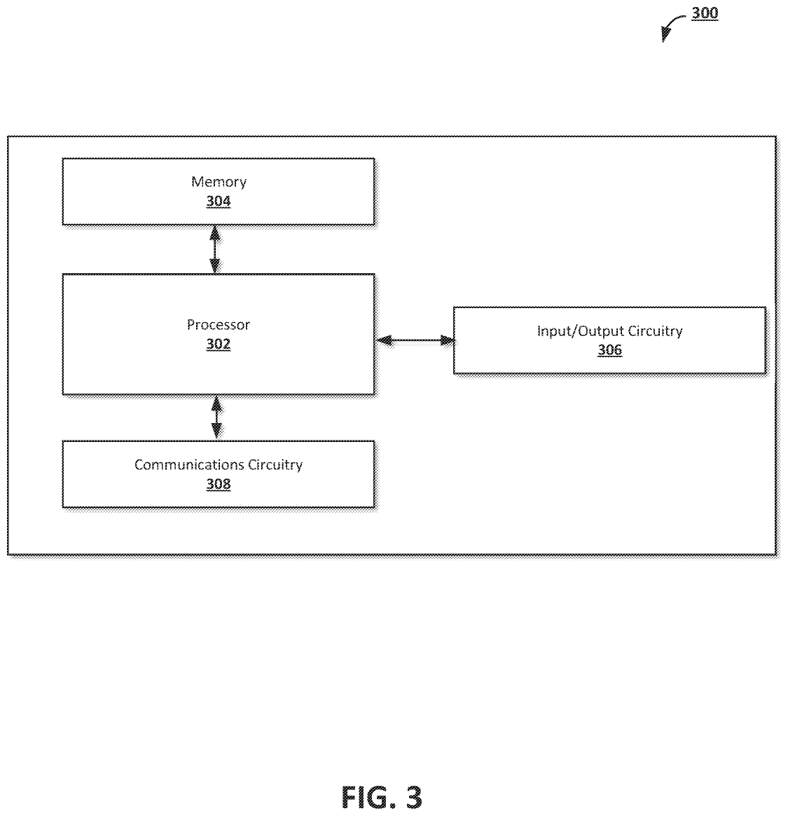

FIG. 3 illustrates a block diagram 300 of exemplary client computing device 106a structured in accordance with one or more embodiments of the present disclosure. The client computing device 106a may be embodied by one or more computing systems. The client computing device 106a may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the client computing device 106a to carry out various functions in accordance with example embodiments of the present invention.

The processor 302 may be embodied in a number of different ways and may, for example, include one or more processing devices configured to perform independently. In some non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some various embodiments, the processor 302 may be configured to execute instructions stored in the memory 304 or otherwise accessible to the processor 302. In some non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the client computing device 106a may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the client computing device 106a are embodied by a limited interaction device, the input/output circuitry 306 includes a touch screen and does not include, or at least does not operatively engage (i.e., when configured in a table mode), other input accessories such as tactile keyboards, track pads, mice, etc. In other embodiments in which the apparatus is embodied by a non-limited interaction device, the input/output circuitry 306 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the client computing device 106a. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of client computing device 106a. In some embodiments, one or more external systems (such as a remote cloud computing and/or data storage system) may also be leveraged to provide at least some of the functionality discussed herein.

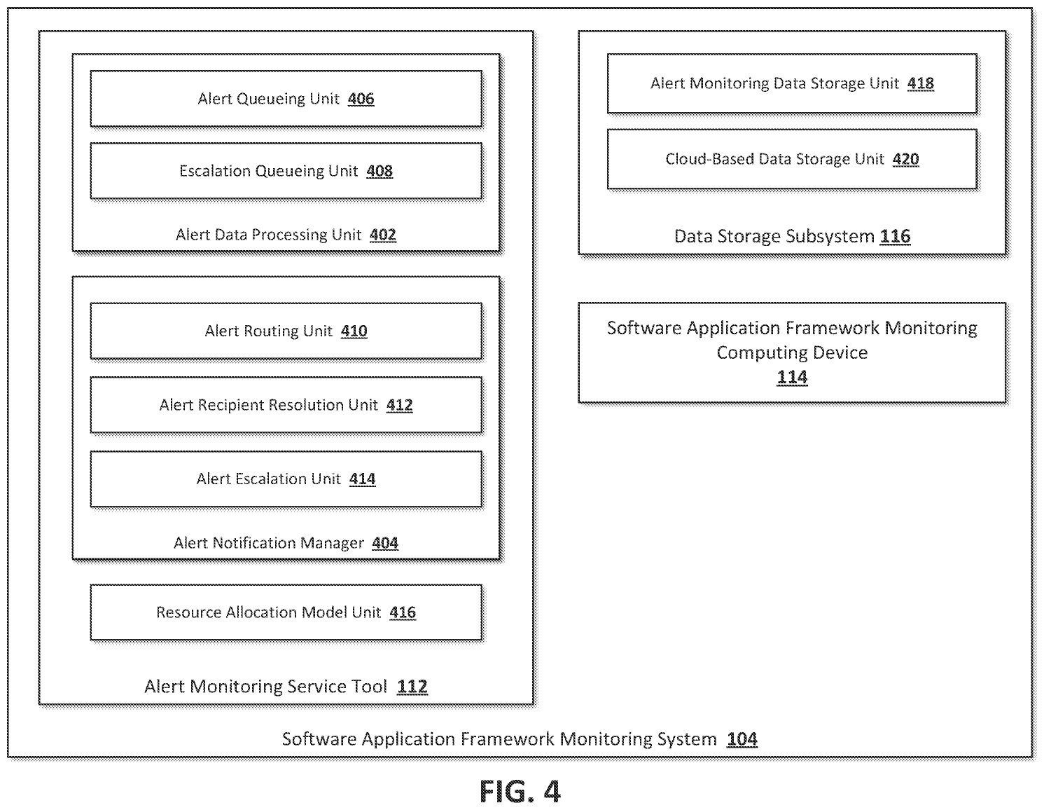

FIG. 4 is a block diagram of an exemplary software application framework monitoring system 104 structured in accordance with one or more embodiments of the present disclosure. As depicted, the software application framework monitoring system 104 comprises an alert monitoring service tool 112, a data storage subsystem 116, and/or a software application framework monitoring computing device 114. The alert monitoring service tool 112 comprises an alert data processing unit 402, an alert notification manager 404, and/or a resource allocation model unit 416. As shown, the alert data processing unit 402 comprises an alert queueing unit 406 and/or an escalation queueing unit 408. The alert notification manager 404 comprises an alert routing unit 410, an alert recipient resolution unit 412, and/or an alert escalation unit 414. The data storage subsystem 116 comprises an alert monitoring data storage unit 418 and/or a cloud-based data storage unit 420.

It will be appreciated that, in various embodiments, a software application framework monitoring system 104 may comprise one or more additional, unillustrated hardware components, software components, and/or one or more combinations thereof that are configured to implement, assist, and/or otherwise facilitate the execution of one or more of the techniques, methods, and/or processes described herein. As such, the various components depicted in FIG. 4 as well as the accompanying descriptions are provided herein for purposes of explanation and not of limitation.

In various examples, the alert monitoring service tool 112 may be configured to monitor one or more software application frameworks 102a-n to determine whether one or more alerts, cautions, problems, errors, issues, and/or incidents are currently occurring and/or have occurred in the past. For example, as described herein, the alert monitoring service tool 112 may be configured to monitor one or more service-oriented platforms 108 and/or one or more monolithic platforms 110 associated with the one or more software application frameworks 102a-n for various alerts.

To facilitate the monitoring of the one or more software application frameworks 102a-n, the alert monitoring service tool 112 may employ the alert data processing unit 402 to receive and/or retrieve one or more alert data objects 120a-n associated with one or more respective alerts related to the one or more software application frameworks 102a-n. Additionally, in various embodiments, the alert data processing unit 402 may be configured to embody, integrate with, direct, manage, and/or otherwise employ one or more of an alert queueing unit 406 and/or an escalation queueing unit 408. In various examples, the alert queueing unit 406 and/or the escalation queueing unit 408 may be integrated with a third-party, cloud-based queueing service such as, for example, Simple Queue Service (SQS)® by Amazon Web Services®.

In various examples, the alert data processing unit 402 may be employed to organize, sequence, and/or otherwise structure the processing of one or more alert data objects 120a-n received and/or retrieved by the alert monitoring service tool 112. As such, the alert data processing unit 402 may employ an alert queueing unit 406 to determine the order in which one or more alert data objects 120a-n are processed by the alert notification manager 404. Therefore, in some embodiments, the alert queueing unit 406 may dictate an order in which one or more alert notifications 122a-n are generated and/or routed by the alert notification manager 404 based on the order of one or more alert data objects 120a-n. Additionally, the alert data processing unit 402 may employ the escalation queueing unit 408 to determine the order in which one or more alert escalation notifications are generated and/or routed by the alert notification manager 404 based on one or more escalation transactions related to the one or more alerts comprised in the one or more alert data objects 120a-n.

The alert notification manager 404 may be configured to receive and/or retrieve one or more alert data objects 120a-n from the alert data processing unit 402. As shown in FIG. 4, the alert notification manager 404 comprises the alert routing unit 410, the alert recipient resolution unit 412, and the alert escalation unit 414. In various examples, the alert notification manager 404 may be configured to generate one or more alert notifications 122a-n based on one or more alert data objects 120a-n. Furthermore, the alert notification manager 404 may be configured to resolve the routing (e.g., determine one or more appropriate alert response entities 118a-n) and facilitate the transmission of the one or more alert notifications 122a-n.

Additionally, in various examples, the alert notification manager 404 may be configured to implement, execute, and/or otherwise facilitate an alert gating operation associated with the alert monitoring service tool 112. For example, as part of the alert gating operation, the alert notification manager 404 may determine, based on one or more portions of data (e.g., alert severity data) associated with a respective alert data object 120a, that an alert notification 122a associated with the respective alert data object 120a is to be generated and transmitted to one or more alert response entities 118a-n. Alternatively, the alert notification manager 404 may determine, based on one or more portions of data (e.g., alert severity data) associated with a respective alert data object 120a, to revert (e.g., remit, defer, bypass) the alert back to the respective software application framework 102a without routing an alert notification 122a to one or more alert response entities 118a-n.

The alert routing unit 410 may be configured to parse one or more alert data objects 120a-n for data related to the respective alerts associated with the alert data objects 120a-n. For example, the alert routing unit 410 may be configured to access one or more alert attributes, one or more alert configuration parameters, and/or an escalation parameter set associated with the one or more alert data objects 120a-n.

In various examples, the one or more alert attributes may include an alert identifier, an alert description, a tag identifier, a log identifier, a service identifier, and/or at least one alert response entity identifier. As such, the alert routing unit 410 may parse the one or more alert attributes associated with a respective alert data object 120a to determine the respective software application framework 102a associated with the alert data object 120a. Furthermore, the alert routing unit 410 may determine (e.g., identify) the specific component (e.g., hardware component, software component, service, product, etc.) of the respective software application framework 102a that caused the alert and how the specific component failed (e.g., erred, broke, and/or degraded).

Additionally, the alert routing unit 410 may parse the alert configuration parameters associated with a respective alert data object 120a to determine one or more alert response entity rules, data related to one or more alert response entities 118a-n, data related to a respective alert response team, data related to a visibility policy associated with the alert data object 120a, data related to a notification policy associated with the alert data object 120a, and/or data related to an escalation parameter set.

In one or more embodiments, the alert response entity rules may dictate the distribution, scheduling, and/or transmission of one or more alert notifications 122a-n associated with a respective alert data object 120a. In some examples, the alert routing unit 410 may use a set of alert response entity rules to determine a hierarchy of one or more alert response entities 118a-n associated with a respective software application framework 102a (e.g., a hierarchy of one or more members of a respective alert response team). In some embodiments, the alert response entity rules may also dictate a preferred form of communication associated with one or more alert response entities 118a-n and, therefore, a respective type of alert notification 122a (e.g., email, SMS message, etc.) to be transmitted to the one or more alert response entities 118a-n.

As such, the alert routing unit 410 may be configured to determine, according to the one or more alert response entity rules, notification policy, and/or visibility policy, one or more appropriate (e.g., intended) alert response entities 118a-n to be notified of the alert associated with a respective alert data object 120a. The alert routing unit 410 may then transmit this data to the alert recipient resolution unit 412 for processing (e.g., generating and/or transmitting) one or more respective alert notifications 122a-n for the one or more appropriate alert response entities 118a-n.

The alert recipient resolution unit 412 may be configured to employ the one or more portions of data parsed and/or compiled by the alert routing unit 410 to generate and facilitate the transmission of one or more alert notifications 122a-n to one or more alert response entities 118a-n associated with a respective software application framework 102a. In various examples, the alert recipient resolution unit 412 may generate and transmit one or more alert notifications 122a-n based on a schedule determined by the alert routing unit 410 (e.g., indicated by one or more alert response entity rules). Furthermore, the alert recipient resolution unit 412 may generate one or more alert notifications 122a-n based on a preferred form of communication associated with one or more respective alert response entities 118a-n (e.g., an email notification, an SMS message, a mobile device push message, and/or the like).

In this regard, the alert recipient resolution unit 412 may be configured to establish one or more connections (e.g., via the network 124) to one or more alert response entities 118a-n based on the data parsed and/or compiled by the alert routing unit 410. For example, the alert recipient resolution unit 412 may establish one or more connections to one or more alert response entities 118a-n based on one or more alert response entity identifiers associated with a respective notification policy related to a respective alert data object 120a. As such, based on the one or more established connections, the alert recipient resolution unit 412 can cause the transmission of one or more alert notifications 122a-n to the one or more respective alert response entities 118a-n.

Furthermore, in some examples, the alert recipient resolution unit 412 may be configured to update, in conjunction with the data storage subsystem 116, one or more data stores based in part on a visibility policy associated with a respective alert data object 120a. For example, based on the visibility policy, the alert recipient resolution unit 412 may update and/or augment a respective data store such that only the intended alert response entities 118a-n will have access permissions to view data related to the respective alert data object 120a.

In various examples, as a result of the alert gating operation executed by the alert monitoring service tool 112, the alert recipient resolution unit 412 may determine that a first alert notification 122a (e.g., a gating alert notification) is to be generated based on a respective alert data object 120a and transmitted to one or more respective alert response entities 118a-n (e.g., as defined by the respective notification policy). The first alert notification 122a (e.g., the gating alert notification) may be routed to a first set of respective alert response entities 118a-n, where the first set of respective alert response entities 118a-n comprise one or more gating alert responders. In various examples, the one or more gating alert responders may be one or more low-tier alert response entities configured as a first line of alert mitigation for the respective software application framework 102a. The one or more gating alert responders may be determined based in part on one or more alert response entity rules associated with the respective alert data object 120a.

Additionally, under the direction of the alert escalation unit 414, the alert recipient resolution unit 412 may be configured to facilitate the transmission of one or more alert escalation notifications to one or more respective alert response entities 118a-n (e.g., one or more alert escalation responders identified by the alert routing unit 410). The one or more alert escalation notifications may be associated with one or more respective escalation transactions generated by the alert escalation unit 414. In some examples, the alert recipient resolution unit 412 is configured to establish one or more connections to one or more respective alert response entities 118a-n via a respective escalation transaction generated by the alert escalation unit 414.

The alert escalation unit 414 may determine, based on the data comprised in an escalation parameter set associated with a respective alert data object 120a, whether an alert needs to be escalated. Furthermore, the alert escalation unit 414, in conjunction with the alert routing unit 410, can determine, based on the escalation parameter set, which responsible alert response entities 118a-n (e.g., alert escalation entities) are intended to be notified of the alert escalation and/or when the responsible alert response entities 118a-n are to be notified.

In various examples, the escalation parameter set may comprise one or more alert escalation configuration parameters including, but not limited to, one or more alert escalation rules, alert escalation schedules, alert escalation progression time periods, alert escalation entity identifiers, and/or an alert escalation repetition value associated with the respective alert data object 120a. Additionally, in various embodiments, a respective escalation parameter set associated with an alert data object 120a may comprise data indicating an alert severity level, an alert priority level, an alert importance, an alert ranking, and/or the like associated with a respective alert. For example, an associated alert severity level may indicate whether the alert needs to be escalated (e.g., brought to the attention of multiple and/or specific alert response entities 118a-n) if the alert is not mitigated and/or acknowledged by a first alert response entity 118a (e.g., a gating alert responder entity) within a predetermined alert escalation progression time period.

For example, a set of alert response entity rules may dictate that a first alert notification 122a (e.g., a gating alert notification) is to be transmitted to a first alert response entity 118a (e.g., a gating alert responder entity associated with a first alert response team). If the alert monitoring service tool 112 (e.g., via the alert escalation unit 414) determines that the alert associated with the first alert notification 122a is to be escalated (e.g., an escalation progression time period has expired before the first alert response entity 118a responds to the first alert notification 122a), a set of alert escalation rules associated with a respective escalation parameter set may dictate that a second alert notification 122b (e.g., an alert escalation notification) is to be transmitted to a second alert response entity 118b (e.g., an escalation entity associated with a second alert response team).

If the alert escalation unit 414 determines that a respective alert is to be escalated, the alert escalation unit 414 may be configured to generate an escalation transaction associated with an alert data object 120a related to the respective alert. The alert escalation unit 414 may employ the escalation transaction to facilitate the communication (e.g., transmission) of one or more alert notifications 122a-n (e.g., alert escalation notifications) to one or more alert response entities 118a-n (e.g., a respective alert response team, one or more alert escalation responders, and/or the like). The escalation transaction may be generated by the alert escalation unit 414 based on the escalation parameter set associated with the respective alert data object 120a.

In various examples, the alert escalation unit 414 can generate a single escalation transaction associated with a respective alert data object 120a and, as such, the single escalation transaction can be employed to facilitate the transmission of one or more alert escalation notifications to one or more respective alert response entities (e.g., alert escalation responders). For example, a single escalation transaction may be used to communicate multiple alert escalation notifications for an alert escalation that is repeated (e.g., looped, cycled, etc.) according to an escalation repetition value associated with the respective alert data object 120a.

In some examples, an escalation parameter set may comprise an alert escalation repetition value that indicates how many times an alert escalation is to be repeated. For example, if the alert escalation unit 414 determines that an alert has been fully escalated and each respective alert escalation entity associated with the respective alert data object 120a has been notified, yet the alert has not been acknowledged, the alert escalation unit 414 may restart the alert escalation process from the beginning. As such, the alert escalation unit 414 may be configured to restart the alert escalation process a predetermined number of times indicated by the escalation repetition value.

In addition to the alert data processing unit 402 and the alert notification manager 404, the alert monitoring service tool 112 also comprises the resource allocation model unit 416. In various examples, the resource allocation model unit 416 may be configured to deploy, direct, train, and/or otherwise manage the resource allocation model associated with the alert monitoring service tool 112. As described herein, the resource allocation model associated with the alert monitoring service tool 112 may be configured to mitigate any adverse impacts to a respective software application framework 102a and/or a respective software application framework monitoring system 104 caused by excessive alert generation, excessive alert escalation, and/or excessive resource consumption by one or more components of the software application framework 102a. In this regard, the resource allocation model is configured to adaptively balance the alert monitoring service resource consumption for one or more software application frameworks 102a-n.

A resource allocation model may be configured to determine whether a software application framework 102a has satisfied (e.g., met and/or exceeded) an alert monitoring service resource threshold. The alert monitoring service resource threshold may be associated with a predetermined allotment of software application framework monitoring resources, communications network resources, personnel resources, computational resources, data storage resources, and/or the like that have been provided for a respective software application framework 102a.

A resource allocation model may be configured to, in response to determining that an alert monitoring service resource threshold has been satisfied (e.g., met and/or exceeded) for a respective software application framework 102a, apply a de-prioritization flag to one or more client computing devices 106a-n associated with the software application framework 102a. As such, the resource allocation model may be configured to apply one or more restrictions to one or more alert monitoring service resources associated with the one or more client computing devices 106a-n associated with the de-prioritization flag.

In various embodiments, the resource allocation model unit 416 may be configured to train, re-train, update, and/or otherwise augment a resource allocation model (and/or one or more models associated with the resource allocation model) based on one or more portions of alert data associated with one or more alert data objects 120a-n that have been generated, received, stored, and/or otherwise managed by the alert monitoring service tool 112 and stored in the data storage subsystem 116.

As depicted in FIG. 4, the data storage subsystem 116 comprises the alert monitoring data storage unit 418 and the cloud-based data storage unit 420. In one or more examples, the data storage subsystem 116 may be configured to store, receive, retrieve, transmit, and/or otherwise manage one or more portions of data related to one or more alert data objects 120a-n. Additionally, in various examples, the data storage subsystem 116 may be configured to store, receive, retrieve, transmit, and/or otherwise manage one or more portions of data related to one or more alert monitoring event objects. Additionally, in various examples, the data storage subsystem 116 may be configured to store, receive, retrieve, transmit, and/or otherwise manage one or more portions of data related to the resource allocation model associated with the alert monitoring service tool 112 (e.g., resource allocation model training data, resource allocation model output, and/or the like).

In various embodiments, the alert monitoring data storage unit 418 may be configured to publish, transmit, and/or store data related to one or more alert data objects 120a-n, one or more alert monitoring event objects, and/or resource allocation model data to one or more data stores (e.g., databases, memories, server systems, and/or the like) associated with the software application framework monitoring system 104. Additionally, in various embodiments, the cloud-based data storage unit 420 may be configured to publish, transmit, and/or store data related to one or more alert data objects 120a-n, one or more alert monitoring event objects, and/or resource allocation model data to one or more cloud-based storage platforms (e.g., cloud-based databases, cloud-based data-querying tools, and/or the like) associated with the software application framework monitoring system 104.

### Example Data Flows of the Disclosure

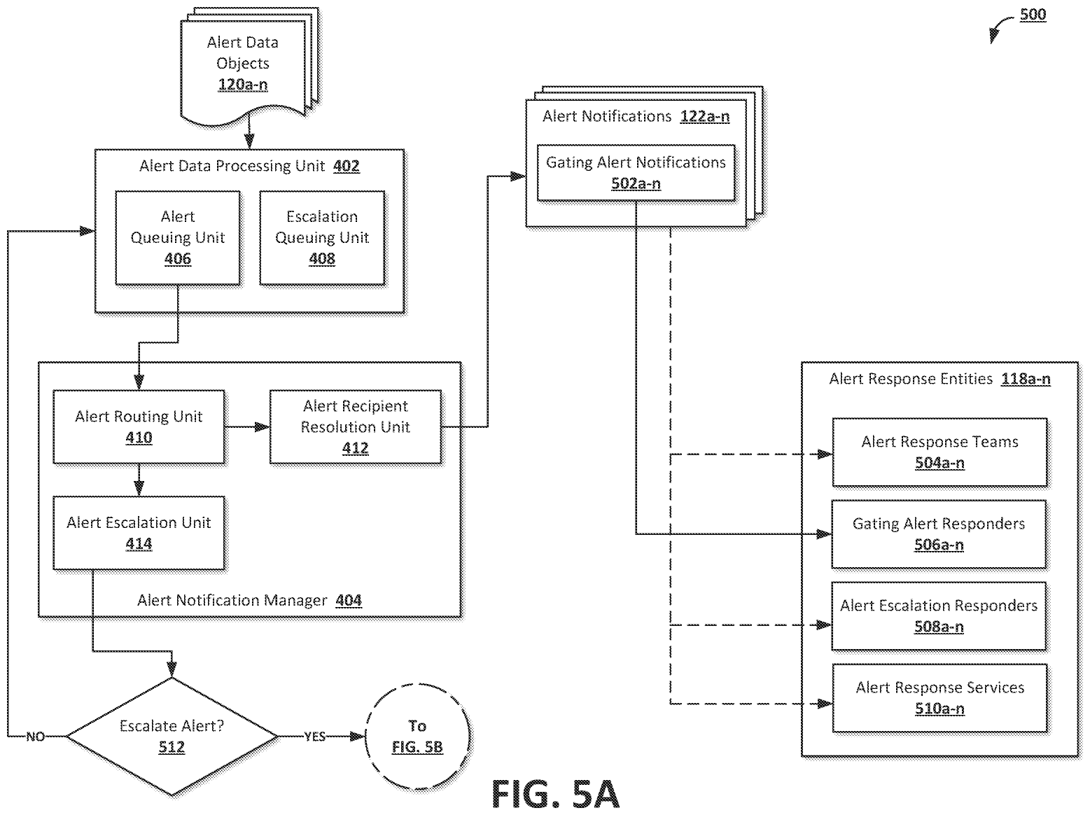

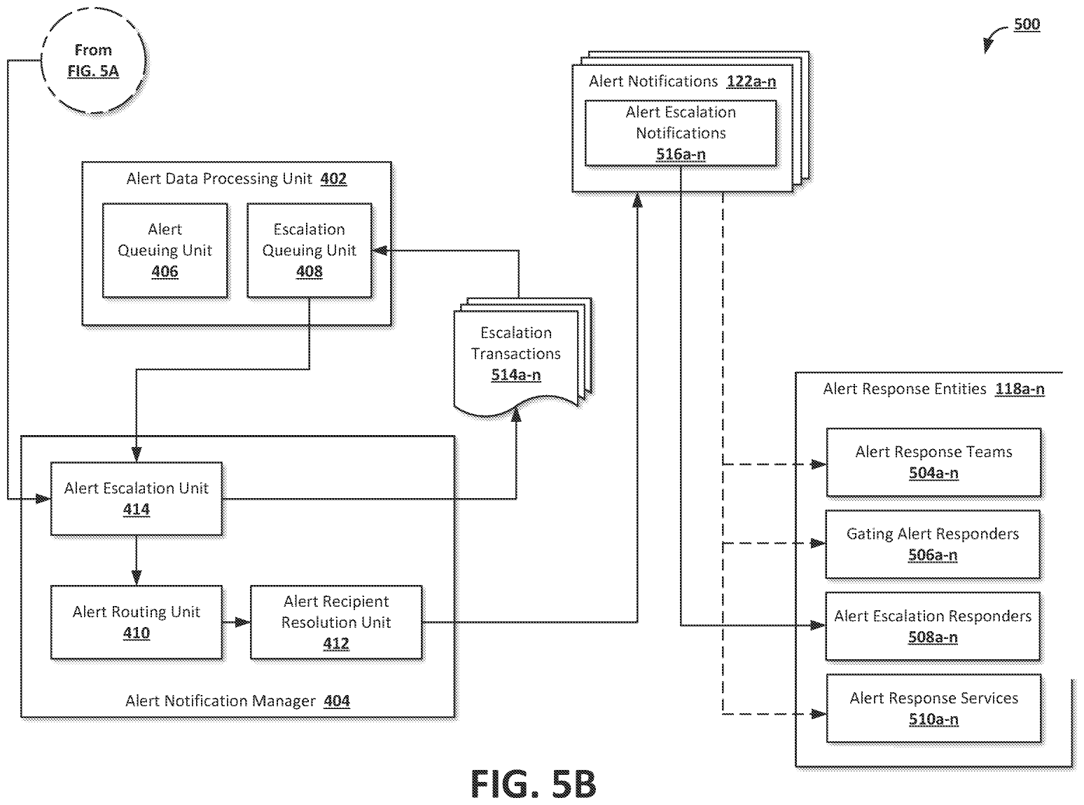

FIGS. 5A-B illustrate an exemplary data flow diagram 500 for generating and routing alert notifications 122a-n associated with respective alert data objects in accordance with one or more embodiments of the present disclosure. Specifically, FIGS. 5A-B illustrate the flow of data related to one or more alert data objects 120a-n that have been received and/or retrieved by the alert data processing unit 402 of an alert monitoring service tool 112 and the subsequent generation and routing of the alert notifications 122a-n.

Upon receiving the one or more alert data objects 120a-n, the alert data processing unit 402 may be configured to organize and/or schedule the one or more alert data objects 120a-n for processing by the alert notification manager 404. In various examples, the alert data processing unit 402 may employ the alert queueing unit 406 to sequence the processing of one or more alert data objects 120a-n detected by the alert monitoring service tool 112. As shown in FIG. 5A, the alert data processing unit 402 (e.g., via the alert queueing unit 406) may transmit the one or more alert data objects 120a-n to the alert routing unit 410.

As described herein, the alert routing unit 410 may be configured to parse the one or more alert data objects 120a-n for data related to the respective alerts associated with the alert data objects 120a-n. For example, the alert routing unit 410 may be configured to access one or more alert attributes, one or more alert configuration parameters, and/or an escalation parameter set associated with the one or more alert data objects 120a-n. The alert routing unit 410 may then transmit this data to the alert recipient resolution unit 412 for processing (e.g., generating and/or transmitting) one or more respective alert notifications 122a-n for the one or more appropriate alert response entities 118a-n.

As described herein, the alert notification manager 404 may be configured to implement, execute, and/or otherwise facilitate an alert gating operation. For example, as part of the alert gating operation, the alert notification manager 404 may determine, based on one or more portions of data (e.g., alert severity data) associated with a respective alert data object 120a, that an alert notification 122a associated with the respective alert data object 120a is to be generated and transmitted to one or more alert response entities 118a-n. Alternatively, the alert notification manager 404 may determine, based on one or more portions of data (e.g., alert severity data) associated with a respective alert data object 120a, to revert (e.g., remit, defer, bypass) the alert back to the respective software application framework 102a without routing an alert notification 122a to one or more alert response entities 118a-n.

In various examples, the alert notification manager 404 associated with the alert monitoring service tool 112 may be configured to determine (e.g., via the alert routing unit 410) that a respective alert data object 120a is associated with a severity level that satisfies an alert gating threshold (e.g., the severity level meets and/or exceeds the alert gating threshold). In such examples, the alert notification manager 404 may direct the alert recipient resolution unit 412 to generate one or more gating alert notifications 502a-n. The alert recipient resolution unit 412 may then facilitate the transmission of the one or more gating alert notifications 502a-n to one or more appropriate alert response entities 118a-n. For example, the alert recipient resolution unit 412 may establish a connection with one or more gating alert responders 506a-n and transmit the one or more gating alert notifications 502a-n to the one or more gating alert responders 506a-n via the established connections.

In various examples, the one or more gating alert responders 506a-n may be one or more low-tier alert response entities 118a-n configured as a first line of alert mitigation for the respective software application framework 102a. The one or more gating alert responders 506a-n may be determined (e.g., via the alert routing unit 410) based in part on one or more alert response entity rules associated with the respective alert data object 120a. As shown in FIG. 5A, the one or more alert response entities 118a-n may also comprise one or more alert response teams 504a-n, alert escalation responders 508a-n, and/or alert response services 510a-n.

As depicted, the alert notification manager 404 may be configured to facilitate the simultaneous transmission of one or more alert notifications 122a-n to one or more alert response entities 118a-n. In some examples, multiple alert notifications 122a-n generated based on a single alert data object 120a may be transmitted to various alert response entities 118a-n based on one or more alert response entity rules and/or a notification policy associated with the alert data object 120a. For example, multiple alert notifications 122a-n generated based on a single alert data object 120a may be simultaneously transmitted to one or more alert response teams 504a-n and/or one or more alert response services 510a-n.

Furthermore, in various examples, the alert notification manager 404 may grant viewing permissions to one or more alert response entities 118a-n based on a visibility policy associated with the alert data object 120a. For example, one or more alert response teams 504a-n, gating alert responders 506a-n, alert escalation responders 508a-n, and/or alert response services 510a-n may be granted access to view data related to a respective alert data object 120a regardless of whether the one or more alert response teams 504a-n, gating alert responders 506a-n, alert escalation responders 508a-n, and/or alert response services 510a-n have been selected to receive one or more alert notifications 122a-n related to the respective alert data object 120a.

As shown in FIG. 5A, the alert routing unit 410 may also be configured to pass data related to the one or more alert data objects 120a-n to the alert escalation unit 414. As illustrated by decision block 512, the alert escalation unit 414 may be configured to determine whether an alert needs to be escalated to one or more additional alert response entities 118a-n (e.g., in addition to one or more previously notified gating alert responders 506a-n). In various examples, the alert escalation unit 414 may determine whether an alert needs to be escalated based on the data comprised in an escalation parameter set associated with a respective alert data object 120a. In examples in which a respective alert does not need to be escalated, the alert escalation unit 414 may be configured to signal to the alert data processing unit 402 that the alert notification manager 404 is available to receive one or more subsequent alert data objects 120a-n from the alert queueing unit 406.

However, the alert escalation unit 414 may determine that a respective alert associated with a first alert notification (e.g., a gating alert notification 502a) is to be escalated. For example, the alert escalation unit 414 may determine that an escalation progression time period associated with the respective alert has expired before a gating alert responder 506a responds to (e.g., acknowledges) the first alert notification (e.g., the gating alert notification 502a). In such an example, a set of alert escalation rules associated with a respective escalation parameter set related to the respective alert may dictate that a second alert notification (e.g., an alert escalation notification 516a) is to be transmitted to a second alert response entity (e.g., an alert escalation responder 508a).

As illustrated in FIG. 5B, if the alert escalation unit 414 determines that a respective alert is to be escalated, the alert escalation unit 414 may be configured to generate an escalation transaction 514a associated with an alert data object 120a related to the respective alert. The alert escalation unit 414 may employ the escalation transaction 514a to facilitate the communication (e.g., transmission) of one or more alert escalation notifications 516a-n to one or more alert response entities 118a-n (e.g., one or more alert escalation responders 508a-n. The escalation transaction 514a may be generated by the alert escalation unit 414 based on the escalation parameter set associated with the respective alert data object 120a.

In various examples, the alert escalation unit 414 can generate a single escalation transaction 514a associated with a respective alert data object 120a and, as such, the single escalation transaction 514a can be employed to facilitate the transmission of one or more alert escalation notifications 516a-n to one or more respective alert response entities 118a-n (e.g., one or more alert escalation responders 508a-n). For example, a single escalation transaction 514a may be used to communicate multiple alert escalation notifications 516a-n for an alert escalation that is repeated (e.g., looped, cycled, etc.) according to an escalation repetition value associated with the respective alert data object 120a.

In one or more embodiments, the alert data processing unit 402 may be configured to employ the escalation queueing unit 408 to schedule, sequence, and/or otherwise organize one or more escalation transactions 514a-n associated with one or more alerts related to one or more respective alert data objects 120a-n. As such, in some examples, the escalation queueing unit 408 may determine the order in which one or more alert escalation notifications 516a-n are generated and/or routed by the alert notification manager 404 based on the one or more escalation transactions 514a-n.

As illustrated, the alert escalation unit 414 works in tandem with the alert routing unit 410 and/or the alert recipient resolution unit 412 to facilitate the generation and routing of the one or more alert escalation notifications 516a-n associated with the one or more respective escalation transactions 514a-n. For example, the alert routing unit 410 may be configured to parse one or more portions of data related to an escalation parameter set (e.g., alert escalation entity identifiers) associated with the alert being escalated and transmit the one or more portions of data to the alert recipient resolution unit 412. As such, the alert recipient resolution unit 412 may be configured to generate and facilitate the transmission of one or more alert escalation notifications 516a-n via a respective escalation transaction 514a. In various examples, the one or more alert escalation notifications 512a-n may be transmitted to one or more alert escalation responders 508a-n.

### Example Processes of the Disclosure

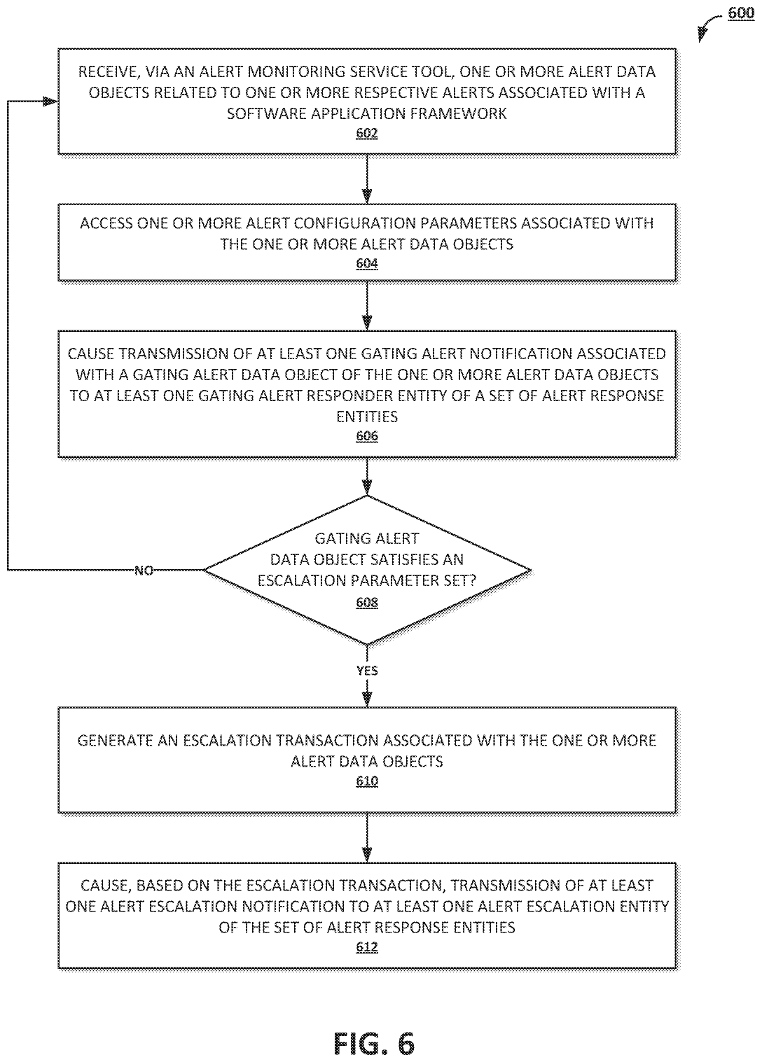

FIG. 6 illustrates a flowchart representing a method for adaptive alert monitoring, routing, and escalation for one or more software application frameworks in accordance with one or more embodiments of the present disclosure. In some embodiments, the method 600 is embodied by computer program code stored on a non-transitory computer-readable storage medium of a computer program product configured for execution to perform the process as depicted and described. Additionally or alternatively, in some embodiments, the method 600 is performed by one or more specially configured computing devices, such as the software application framework monitoring computing device 114 alone or in communication with one or more other components, devices, and/or systems (e.g., an alert monitoring service tool 112 and/or a data storage subsystem 116).

In this regard, the software application framework monitoring computing device 114 may be specially configured by computer-coded instructions (e.g., computer program instructions) stored thereon, for example in the memory 204 and/or another component depicted and/or described herein and/or otherwise accessible to the software application framework monitoring computing device 114, for performing the operations as depicted and described. In some embodiments, the software application framework monitoring computing device 114 is in communication with one or more external apparatuses, systems, devices, and/or the like, to perform one or more of the operations as depicted and described. For purposes of simplifying the description, the method 600 is described as performed by and from the perspective of the software application framework monitoring computing device 114.

The method 600 begins at operation 602. At operation 602, the software application framework monitoring computing device 114 includes means such as the communications circuitry 208, input/output circuitry 206, memory 204, and/or processor 202, or any combination thereof, that receive, via an alert monitoring service tool 112, one or more alert data objects 120a-n related to one or more respective alerts associated with a software application framework 102a. For example, as described herein, the alert monitoring service tool 112 is configured to monitor one or more software application frameworks 102a-n to detect one or more alerts, cautions, problems, errors, issues, and/or incidents. In some examples, the one or more alerts may be associated with one or more of a service-oriented platform 108 and/or a monolithic platform 110 associated with a respective software application framework 102a.

In various examples, the one or more alert data objects 120a-n may be generated by an alert monitoring service application programming interface (API) associated with the alert monitoring service tool 112. In various examples, the alert monitoring service API may be configured to automatically generate an alert data object 120a upon the detection of a respective alert, caution, problem, error, issue, and/or incident associated with a respective software application framework of the software application frameworks 102a-n. As such, the alert monitoring service tool 112 may, in various examples, automatically receive one or more alert data objects 120a-n generated by the alert monitoring service API.

At operation 604, the software application framework monitoring computing device 114 includes means such as the communications circuitry 208, input/output circuitry 206, memory 204, and/or processor 202, or any combination thereof, that access one or more alert configuration parameters associated with the one or more alert data objects 120a-n. As described herein, a set of alert configuration parameters associated with an alert data object 120a may comprise, but is not limited to, one or more alert response entity rules, data related to one or more alert response entities 118a-n, data related to a respective alert response team 504a, data related to a visibility policy associated with the alert data object 120a, data related to a notification policy associated with the alert data object 120a, and/or data related to an escalation parameter set.

At operation 606, the software application framework monitoring computing device 114 includes means such as the communications circuitry 208, input/output circuitry 206, memory 204, and/or processor 202, or any combination thereof, that cause, based in part on the one or more alert configuration parameters, transmission of at least one gating alert notification 502a associated with a gating alert data object of the one or more alert data objects 120a-n to at least one gating alert responder 506a of a set of alert response entities 118a-n.

For example, the alert notification manager 404 associated with the alert monitoring service tool 112 may be configured to determine (e.g., via the alert routing unit 410) that a respective alert data object 120a is associated with a severity level that satisfies an alert gating threshold (e.g., the severity level meets and/or exceeds the alert gating threshold). As such, the alert notification manager 404 may direct the alert recipient resolution unit 412 to generate one or more gating alert notifications 502a-n. The alert recipient resolution unit 412 may then facilitate the transmission of the one or more gating alert notifications 502a-n to at least one gating alert responder 506a of a set of alert response entities 118a-n.

At operation 608, the software application framework monitoring computing device 114 includes means such as the communications circuitry 208, input/output circuitry 206, memory 204, and/or processor 202, or any combination thereof, that determine whether the gating alert data object satisfies an escalation parameter set. The alert escalation unit 414 of the alert monitoring service tool 112 may determine whether an alert needs to be escalated based on data comprised in an escalation parameter set associated with a respective alert data object 120a. For example, the alert escalation unit 414 may determine that an escalation progression time period associated with the respective alert has expired before a gating alert responder 506a responds to (e.g., acknowledges) the first alert notification (e.g., the gating alert notification 502a). In such an example, a set of alert escalation rules associated with a respective escalation parameter set related to the respective alert may dictate that a second alert notification (e.g., an alert escalation notification 516a) is to be transmitted to a second alert response entity (e.g., an alert escalation responder 508a).

At operation 610, the software application framework monitoring computing device 114 includes means such as the communications circuitry 208, input/output circuitry 206, memory 204, and/or processor 202, or any combination thereof, that generate one or more escalation transactions 514a-n associated with the one or more alert data objects 120a-n. In various embodiments, an escalation transaction 514a may be an electronically managed data object comprising one or more portions of executable computer code configured to facilitate the communication (e.g., transmission) of one or more alert notifications 122a-n (e.g., alert escalation notifications 516a-n) to one or more alert response entities 118a-n associated with a respective alert response team 504a. An escalation transaction 514a may be generated by an alert monitoring service tool 112 based on at least one of one or more alert configuration parameters and/or an escalation parameter set associated with a respective alert data object 120a.

At operation 612, the software application framework monitoring computing device 114 includes means such as the communications circuitry 208, input/output circuitry 206, memory 204, and/or processor 202, or any combination thereof, that cause, based on the escalation transaction, transmission of at least one alert escalation notification 516a to at least one alert escalation entity (e.g., an alert escalation responder 508a) of the set of alert response entities 118a-n. For example, as described herein, the alert escalation unit 414 of the alert monitoring service tool 112 can generate a single escalation transaction 514a associated with a respective alert data object 120a and, as such, the single escalation transaction 514a can be employed to facilitate the transmission of one or more alert escalation notifications 516a-n to one or more respective alert response entities 118a-n (e.g., one or more alert escalation responders 508a-n).

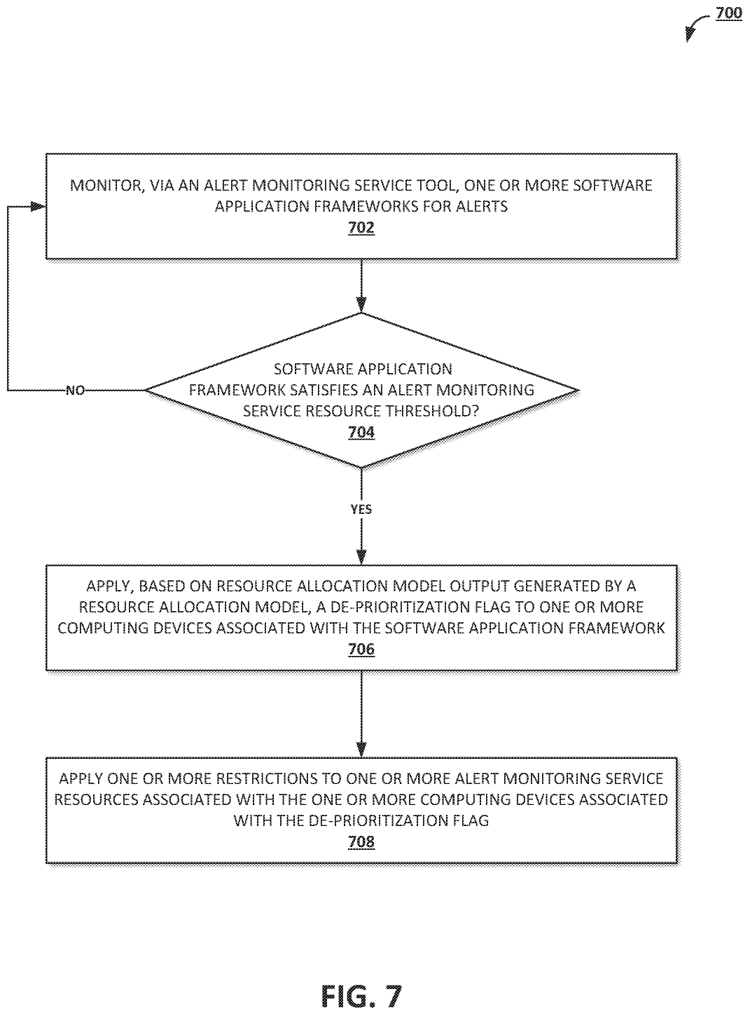

FIG. 7 illustrates a flowchart representing a method for employing a resource allocation model to balance alert monitoring service resource consumption for one or more software application frameworks in accordance with one or more embodiments of the present disclosure. In some embodiments, the method 700 is embodied by computer program code stored on a non-transitory computer-readable storage medium of a computer program product configured for execution to perform the process as depicted and described. Additionally or alternatively, in some embodiments, the method 700 is performed by one or more specially configured computing devices, such as the software application framework monitoring computing device 114 alone or in communication with one or more other components, devices, and/or systems (e.g., an alert monitoring service tool 112 and/or a data storage subsystem 116).

In this regard, the software application framework monitoring computing device 114 may be specially configured by computer-coded instructions (e.g., computer program instructions) stored thereon, for example in the memory 204 and/or another component depicted and/or described herein and/or otherwise accessible to the software application framework monitoring computing device 114, for performing the operations as depicted and described. In some embodiments, the software application framework monitoring computing device 114 is in communication with one or more external apparatuses, systems, devices, and/or the like, to perform one or more of the operations as depicted and described. For purposes of simplifying the description, the method 700 is described as performed by and from the perspective of the software application framework monitoring computing device 114.

The method 700 begins at operation 702. At operation 702, the software application framework monitoring computing device 114 includes means such as the communications circuitry 208, input/output circuitry 206, memory 204, and/or processor 202, or any combination thereof, that monitor, via an alert monitoring service tool 112, one or more software application frameworks 102a-n for alerts.

At operation 704, the software application framework monitoring computing device 114 includes means such as the communications circuitry 208, input/output circuitry 206, memory 204, and/or processor 202, or any combination thereof, that determine, via a resource allocation model associated with the alert monitoring service tool 112, whether a respective software application framework 102a has satisfied (e.g., met and/or exceeded) an alert monitoring service resource threshold. In various examples, the alert monitoring service resource threshold may be associated with a predetermined allotment of software application framework monitoring resources, communications network resources, personnel resources, computational resources, data storage resources, and/or the like that have been provided to a respective software application framework 102a by a respective software application framework monitoring system 104.

If the resource allocation model does not determine that the respective software application framework 102a has satisfied (e.g., met and/or exceeded) the alert monitoring service resource threshold, the method 700 reverts to operation 702. Alternatively, if the resource allocation model does determine that the respective software application framework 102a has satisfied (e.g., met and/or exceeded) the alert monitoring service resource threshold, the method 700 proceeds to operation 706.

At operation 706, the software application framework monitoring computing device 114 includes means such as the communications circuitry 208, input/output circuitry 206, memory 204, and/or processor 202, or any combination thereof, that apply, based on resource allocation model output generated by the resource allocation model, a de-prioritization flag to one or more client computing devices 106a-n associated with the respective software application framework 102a. Additionally or alternatively, in some examples, based on resource allocation model output, a de-prioritization flag may be applied to a particular end user profile associated with the one or more client computing devices 106a-n associated with the respective software application framework 102a. Additionally or alternatively, a de-prioritization flag may be applied to a particular escalation transaction associated with a respective alert data object 120a associated with the respective software application framework 102a based on resource allocation model output.

At operation 708, the software application framework monitoring computing device 114 includes means such as the communications circuitry 208, input/output circuitry 206, memory 204, and/or processor 202, or any combination thereof, that apply one or more restrictions to one or more alert monitoring service resources associated with the one or more client computing devices 106a-n associated with the de-prioritization flag. Based on the one or more restrictions, one or more components of the respective software application framework 102a may be unable to access one or more features associated with the software application framework monitoring system 104 for a predetermined amount of time. For example, the one or more client computing devices 106a-n may be temporarily restricted from performing at least one or more of transmitting one or more alert data objects 120a-n to the alert monitoring service tool 112, making one or more alert data queries associated with the data storage subsystem 116, and/or receiving one or more alert notifications 122a-n. In this regard, a resource allocation model is configured to adaptively balance the alert monitoring service resource consumption for one or more software application frameworks 102a-n.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus.

Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data.

Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. An apparatus for adaptive alert monitoring that is configured to mitigate excessive alert escalation in a software application framework, the apparatus comprising at least one processor and at least one non-transitory memory comprising a computer program code, the at least one non-transitory memory and the computer program code configured to, with the at least one processor, cause the apparatus to:
receive, via an alert monitoring service tool, one or more alert data objects related to one or more respective alerts associated with the software application framework;
access one or more alert configuration parameters associated with the one or more alert data objects;
cause, based in part on the one or more alert configuration parameters, transmission of at least one gating alert notification associated with a gating alert data object of the one or more alert data objects to at least one gating alert responder entity of a set of alert response entities;
determine if the gating alert data object satisfies an escalation parameter set; and
in response to determining that the gating alert data object satisfies the escalation parameter set:
generate an escalation transaction associated with the one or more alert data objects; and
cause, based on the escalation transaction, transmission of at least one alert escalation notification to at least one alert escalation entity of the set of alert response entities.

2. The apparatus of claim 1, wherein the computer program code configured to access the one or more alert configuration parameters further cause the apparatus to:
determine one or more alert response entity rules associated with the one or more alert data objects;
determine a visibility policy associated with the one or more alert data objects, wherein the visibility policy describes one or more alert response entities of the set of alert response entities that have access to view the one or more alert data objects; and
determine a notification policy associated with the one or more alert data objects, wherein the notification policy describes one or more alert response entities of the set of alert response entities that have access to receive one or more of the at least one gating alert notification or the at least one alert escalation notification.

3. The apparatus of claim 1, wherein the set of alert response entities comprises at least one or more alert response teams, gating alert responders, alert escalation responders, or alert response services.

4. The apparatus of claim 1, wherein the one or more alert data objects comprise a respective escalation parameter set, and wherein the respective escalation parameter set comprises at least one or more alert escalation rules, alert escalation schedules, alert escalation progression time periods, alert escalation entity identifiers, or an alert escalation repetition value.

5. The apparatus of claim 1, wherein the one or more alert data objects are associated with one or more alert attributes comprising at least one or more of an alert identifier, an alert description, a tag identifier, a log identifier, a service identifier, or an alert response entity identifier.

6. The apparatus of claim 1, wherein the computer program code further causes the apparatus to:
determine, via a resource allocation model associated with the alert monitoring service tool, whether the software application framework has satisfied an alert monitoring service resource threshold;
in response to determining the alert monitoring service resource threshold has been satisfied:
apply, based on resource allocation model output generated by the resource allocation model, a de-prioritization flag to one or more computing devices associated with the software application framework; and
apply one or more restrictions to one or more alert monitoring service resources associated with the one or more computing devices associated with the de-prioritization flag.

7. The apparatus of claim 6, wherein the de-prioritization flag is applied to a particular end user profile associated with the one or more computing devices associated with the software application framework.

8. The apparatus of claim 6, wherein the de-prioritization flag is applied to a particular escalation transaction associated with a respective alert data object associated with the software application framework.

9. The apparatus of claim 6, wherein the computer program code further causes the apparatus to:
remove the de-prioritization flag from the one or more computing devices upon determining a predefined de-prioritization period has elapsed.

10. The apparatus of claim 1, wherein the computer program code further causes the apparatus to:
generate one or more alert monitoring event objects, wherein the one or more alert monitoring event objects are generated based on at least one of an alert routing event, an alert escalation event, or a de-prioritization event associated with a respective alert data object of the one or more alert data objects; and
cause storage of the one or more alert monitoring event objects in at least one cloud-based storage platform associated with the alert monitoring service tool.

11. The apparatus of claim 1, wherein the one or more alert data objects are generated by an alert monitoring service application programming interface (API) associated with the alert monitoring service tool.

12. A computer-implemented method for adaptive alert monitoring that is configured to mitigate excessive alert escalation in a software application framework, the computer-implemented method comprising:
receiving, via an alert monitoring service tool, one or more alert data objects related to one or more respective alerts associated with the software application framework;
accessing one or more alert configuration parameters associated with the one or more alert data objects;
causing, based in part on the one or more alert configuration parameters, transmission of at least one gating alert notification associated with a gating alert data object of the one or more alert data objects to at least one gating alert responder entity of a set of alert response entities;
determining, via an alert notification manager associated with the alert monitoring service tool, if the gating alert data object satisfies an escalation parameter set; and
in response to determining that the gating alert data object satisfies the escalation parameter set:
generating, via the alert notification manager, an escalation transaction associated with the one or more alert data objects; and
causing, based on the escalation transaction, transmission of at least one alert escalation notification to at least one alert escalation entity of the set of alert response entities.

13. The computer-implemented method of claim 12, wherein accessing the one or more alert configuration parameters further comprises:
determining one or more alert response entity rules associated with the one or more alert data objects;
determining a visibility policy associated with the one or more alert data objects, wherein the visibility policy describes one or more alert response entities of the set of alert response entities that have access to view the one or more alert data objects; and
determining a notification policy associated with the one or more alert data objects, wherein the notification policy describes one or more alert response entities of the set of alert response entities that have access to receive one or more of the at least one gating alert notification or the at least one alert escalation notification.

14. The computer-implemented method of claim 12, wherein the set of alert response entities comprises at least one or more alert response teams, gating alert responders, alert escalation responders, or alert response services.

15. The computer-implemented method of claim 12, wherein the one or more alert data objects comprise a respective escalation parameter set, and wherein the respective escalation parameter set comprises at least one or more alert escalation rules, alert escalation schedules, alert escalation progression time periods, alert escalation entity identifiers, or an alert escalation repetition value.

16. The computer-implemented method of claim 12, wherein the one or more alert data objects are associated with one or more alert attributes comprising at least one or more of an alert identifier, an alert description, a tag identifier, a log identifier, a service identifier, or an alert response entity identifier.

17. The computer-implemented method of claim 12, wherein the computer-implemented method further comprises:
determining, via a resource allocation model associated with the alert monitoring service tool, whether the software application framework has satisfied an alert monitoring service resource threshold;
in response to determining the alert monitoring service resource threshold has been satisfied:
applying, based on resource allocation model output generated by the resource allocation model, a de-prioritization flag to one or more computing devices associated with the software application framework; and
applying one or more restrictions to one or more alert monitoring service resources associated with the one or more computing devices associated with the de-prioritization flag.

18. The computer-implemented method of claim 17, wherein the de-prioritization flag is applied to at least one of a particular end user profile associated with the one or more computing devices or a particular escalation transaction associated with a respective alert data object associated with the software application framework.

19. A computer program product for adaptive alert monitoring that is configured to mitigate excessive alert escalation in a software application framework, the computer program product comprising at least one non-transitory computer-readable storage medium having computer-readable program code portions stored therein, the computer-readable program code portions configured to:
determine, via a resource allocation model associated with an alert monitoring service tool, whether the software application framework has satisfied an alert monitoring service resource threshold;
in response to determining the alert monitoring service resource threshold has not been satisfied:
receive, via the alert monitoring service tool, one or more alert data objects related to one or more respective alerts associated with the software application framework;
access one or more alert configuration parameters associated with the one or more alert data objects;
cause, based in part on the one or more alert configuration parameters, transmission of at least one gating alert notification associated with a gating alert data object of the one or more alert data objects to at least one gating alert responder entity of a set of alert response entities;
determine if the gating alert data object satisfies an escalation parameter set; and
in response to determining that the gating alert data object satisfies the escalation parameter set:
generate an escalation transaction associated with the one or more alert data objects; and
cause, based on the escalation transaction, transmission of at least one alert escalation notification to at least one alert escalation entity of the set of alert response entities.

20. The computer program product of claim 19, wherein the computer-readable program code portions configured to determine the one or more alert configuration parameters are further configured to:
determine one or more alert response entity rules associated with the one or more alert data objects;
determine a visibility policy associated with the one or more alert data objects, wherein the visibility policy describes one or more alert response entities of the set of alert response entities that have access to view the one or more alert data objects; and
determine a notification policy associated with the one or more alert data objects, wherein the notification policy describes one or more alert response entities of the set of alert response entities that have access to receive one or more of the at least one gating alert notification or the at least one alert escalation notification.
